(19) United States
(12) Patent Application Publication
(10) Pub. No.: US 2014/0019137 A1
(43) Pub. Date: Jan. 16, 2014

(54) METHOD, SYSTEM AND SERVER FOR SPEECH SYNTHESIS

(71) Applicant: YAHOO JAPAN CORPORATION, Tokyo (JP)

(72) Inventor: Ikuo KITAGISHI, Tokyo (JP)

(73) Assignee: YAHOO JAPAN CORPORATION, Tokyo (JP)

(21) Appl. No.: 13/939,735

(22) Filed: Jul. 11, 2013

(30) Foreign Application Priority Data
Jul. 12, 2012 (JP) 2012-156123

(51) Int. Cl. G10L 13/04

(52) U.S. Cl. CPC G10L 13/043
USPC 704/260

(57) ABSTRACT

A speech synthesis system synthesizes speech using a reading text and a speech dictionary set, and includes a server apparatus. The server apparatus includes an interface unit open to the public; a speech input reception unit that receives an input of speech from an external terminal through the interface unit to generate a speech dictionary set; a registration information reception unit that receives registration information relating to a speech owner who inputs the speech from the external terminal through the interface unit; a speech dictionary set maintaining unit that maintains a speech dictionary set generated from the speech of which the input has been received in association with the registration information of a person inputting the speech; and a speech dictionary set selecting unit that allows selection of a speech dictionary set maintained in the speech dictionary set maintaining unit from the external terminal through the interface unit.

### CROSS-REFERENCE TO RELATED APPLICATIONS

The present application claims priority to and incorporates by reference the entire contents of Japanese Patent Application No. 2012-156123 filed in Japan on Jul. 12, 2012.

### BACKGROUND OF THE INVENTION

1. Field of the Invention

The present invention relates to a method, system and server for speech synthesis.

2. Description of the Related Art

Conventionally, speech synthesis systems are generally known in which a user designates a speech model stored in a server in advance, and speech data acquired by reading an arbitrary text using the speech model is generated. In such speech synthesis systems, a client (user) selects a specific speaker using a terminal, and speech synthesis of a specific sentence is performed based on characteristics of the speech of the selected speaker on a system operator side.

For example, in Japanese Laid-open Patent Publication No. 2002-23777, as a speech synthesis system configured through a network between a client and a service provider, a technology relating to a speech synthesis system is disclosed in which a specific speaker can be selected from among speakers presented to be selectable by the client, and a speech synthesis process of an arbitrary sentence is performed using speech characteristic data (speech model) of the specific speaker in a server.

However, in the conventional speech synthesis systems, a speech model (speech dictionary) of a specific speaker is generated and maintained in a server in advance. Accordingly, even when a user wishes to use speech synthesis, the user needs to select a dictionary only from among a limited number of speech dictionaries stored in the server in advance, and it is difficult for the user to freely configure his or her own speech as a speech dictionary and store the speech dictionary in the server or to receive speech synthesis data generated by selecting a speech dictionary having characteristics and features satisfying the user's request.

### SUMMARY OF THE INVENTION

According to one aspect of an embodiment, a speech synthesis system synthesizes speech using a reading text and a speech dictionary set. The speech synthesis system includes a server apparatus. The server apparatus includes: an interface unit that is open to a public; a speech input reception unit that receives an input of speech from an external terminal through the interface unit to generate a speech dictionary set; a registration information reception unit that receives registration information relating to a speech owner who is a person inputting the speech from the external terminal through the interface unit; a speech dictionary set maintaining unit that maintains a speech dictionary set generated from the speech of which the input has been received in association with the registration information of the person inputting the speech; and a speech dictionary set selecting unit that allows selection of the speech dictionary set maintained in the speech dictionary set maintaining unit from the external terminal through the interface unit.

According to another aspect of an embodiment, a speech synthesis method is a method for synthesizing speech using a reading text and a speech dictionary set. The speech synthesis method includes: receiving an input of speech from an external terminal through an interface unit, which is open to a public, to generate a speech dictionary set; receiving registration information relating to a speech owner who is a person inputting the speech from the external terminal through the interface unit; maintaining a speech dictionary set generated from the speech of which the input has been received in association with the registration information of the person inputting the speech; and allowing selection of the speech dictionary set maintained in the maintaining from the external terminal through the interface unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram that illustrates an overview of a speech synthesis system according to a first embodiment;

FIG. 2 is a diagram that illustrates an example of functional blocks of a server apparatus of the speech synthesis system according to the first embodiment;

FIG. 3 is a diagram that illustrates an example of a method of maintaining speech dictionary sets in a speech dictionary set maintaining unit of the server apparatus according to the first embodiment;

FIG. 4 is a schematic diagram that illustrates an example of the hardware configuration of the server apparatus according to the first embodiment;

FIG. 5 is a diagram that illustrates an example of the process flow of the server apparatus according to the first embodiment;

FIG. 6 is a diagram that illustrates an example of functional blocks of a server apparatus according to a second embodiment;

FIG. 7 is a diagram that illustrates an example of the process flow of the server apparatus according to the second embodiment;

FIG. 8 is a diagram that illustrates an example of functional blocks of a server apparatus according to a third embodiment;

FIG. 9 is a diagram that illustrates an example of the process flow of the server apparatus according to the third embodiment;

FIG. 10 is a diagram that illustrates an example of functional blocks of a server apparatus according to a fourth embodiment;

FIG. 11 is a diagram that illustrates an example of the process flow of the server apparatus according to the fourth embodiment;

FIG. 12 is a diagram that illustrates an example of functional blocks of a server apparatus according to a fifth embodiment;

FIG. 13 is a diagram that illustrates an example of the process flow of the server apparatus according to the fifth embodiment;

FIG. 14 is a diagram that illustrates an example of functional blocks of a server apparatus according to a sixth embodiment;

FIG. 15 is a diagram that illustrates an example of the process flow of the server apparatus according to the sixth embodiment;

FIG. 16 is a diagram that illustrates an example of functional blocks of an external terminal device of a speech synthesis system according to a seventh embodiment;

FIG. 17 is a schematic diagram that illustrates an example of the hardware configuration of the external terminal device of the speech synthesis system according to the seventh embodiment;

FIG. 18 is a diagram that illustrates an example of the process flow of the external terminal device according to the seventh embodiment;

FIG. 19 is a diagram that illustrates an example of functional blocks of an external terminal device according to an eighth embodiment;

FIG. 20 is a diagram that illustrates an example of the process flow of the external terminal device according to the eighth embodiment;

FIG. 21 is a diagram that illustrates an example of functional blocks of an external terminal device according to a ninth embodiment;

FIG. 22 is a diagram that illustrates an example of the process flow of the external terminal device according to the ninth embodiment;

FIG. 23 is a diagram that illustrates an example of functional blocks of an external terminal device according to the tenth embodiment; and

FIG. 24 is a diagram that illustrates an example of the process flow of the external terminal device according to the tenth embodiment.

### DETAILED DESCRIPTION OF THE PREFERRED EMBODIMENTS

Hereinafter, each embodiment of the present invention will be described with reference to the drawings. However, the present invention is not limited to the embodiments and may be variously modified in a range not departing from the concept thereof.

### First Embodiment

### Overview

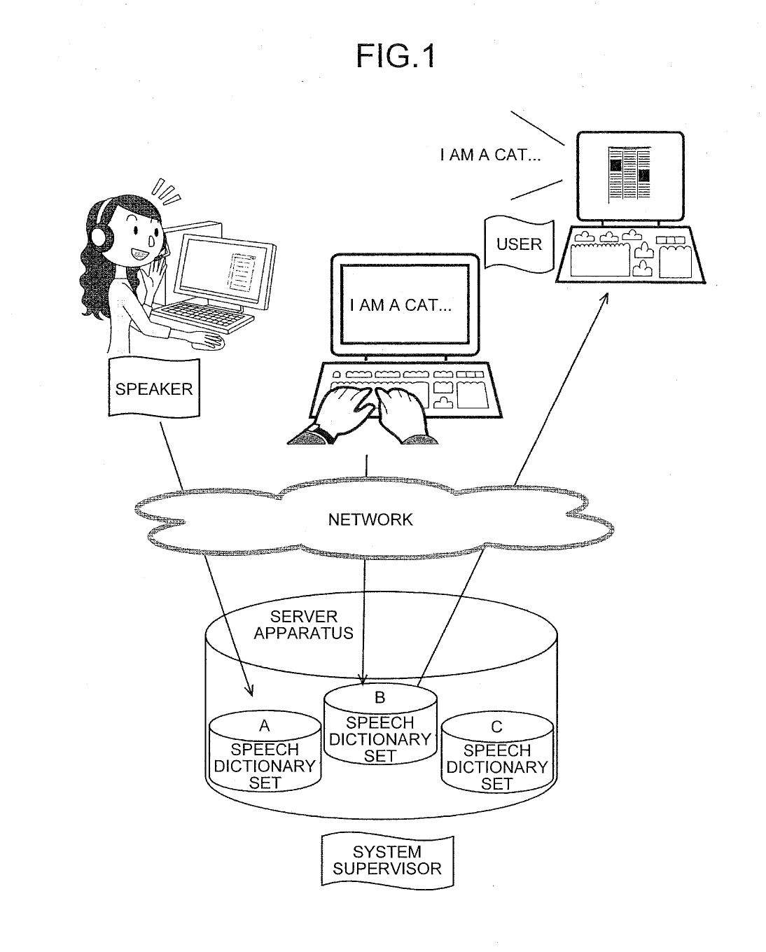

FIG. 1 is a diagram that illustrates an overview of a speech synthesis system according to the first embodiment. As illustrated in FIG. 1, a speaker provides a system operator with speech data through an interface that is open to the public. A server apparatus managed by the system operator configures a database in which a plurality of speech dictionary sets are maintained by generating a speech dictionary set based on the provided speech data. A user selects one speech dictionary set that matches conditions requested from the user from among the speech dictionary sets. In an example illustrated in FIG. 1, the user selects “speech dictionary set B” from among a plurality of speech dictionary sets and inputs a reading text of which the content is “I am a cat” to an external terminal. Then, the user is provided with synthesized speech of “I am a cat” in accordance with speech information having characteristics “B” maintained in the speech dictionary set.

The functional blocks of the server apparatus to be described hereinafter and a speech synthesis terminal to be described later may be implemented as hardware, software, or both hardware and software. More particularly, when a computer is used, there are hardware configuration units such as a CPU (Central Processing Unit), main memory, a bus, a secondary storage device (a storage medium such as a hard disk, non-volatile memory, a CD (Compact Disc) or a DVD (Digital Versatile Disc), a drive reading such a medium, or the like), an input device used for inputting information, a printing device, a display device, a microphone, a speaker, and other external peripheral devices, interfaces for the other external peripheral devices, a communication interface, a driver program and an application program used for controlling such hardware, an application program for a user interface, and the like.

Then, by a calculation process performed by the CPU in accordance with a program loaded in the main memory, data or the like that is input from an input device or any other interface and held in the memory or the hard disk is processed or stored; or a command used for controlling the hardware or the software is generated. Here, the program may be implemented as a plurality of modularized programs or may be implemented as one program by combining two or more programs.

In addition, the present invention may be implemented not only as an apparatus but also as a method. Furthermore, a part of such an apparatus may be configured by software. In addition, it is natural that a software product used for executing such software in a computer and a storage medium acquired by fixing such a product on a recording medium belong to the technical scope of the present invention as well (the present invention is not limited to this embodiment, and this applies the same to the other embodiments).

### Functional Configuration

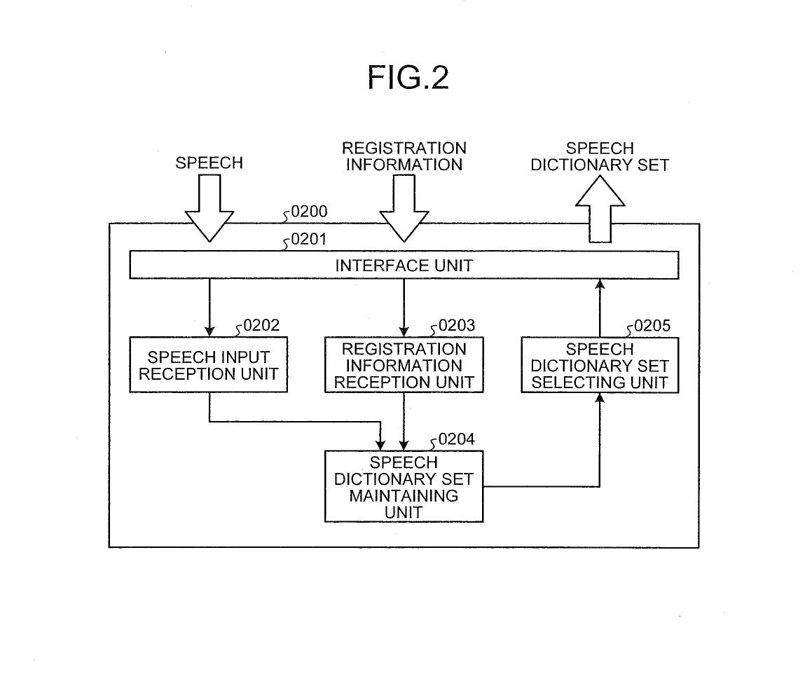

FIG. 2 is a diagram that illustrates an example of functional blocks of a server apparatus of the speech synthesis system according to the first embodiment. As illustrated in FIG. 2, the “server apparatus” 0200 of the “speech synthesis system” according to the first embodiment is configured by an “interface unit” 0201, a “speech input reception unit” 0202, a “registration information reception unit” 0203, a “speech dictionary set maintaining unit” 0204, and a “speech dictionary set selecting unit” 0205.

The “interface unit” is open to the public and has a function for mediating the transmission/reception of various kinds of information between an external terminal device and the server apparatus. Since the interface unit is “open to public”, in principle, any user using a computer can freely transmit or receive information to or from the server apparatus using the external terminal device. Here, as information that can be transmitted or received, for example, text information, image information, or the like may be considered, and, naturally, speech information is included in the information, which can be transmitted or received, described herein. As above, by employing the configuration of the server apparatus that allows the interface for transmitting and receiving speech information to be open to the public, a speaker who desires his or her speech to be open to the public as a speech dictionary so as to be used by many users can provide speech information through a network simply and freely, and the server supervisor can be provided with the speech information from a wide range of speakers through a network. In other words, as far as the transmission and reception of the speech information is performed through an interface that is open to the public, the interface does not need to be one system. In short, an interface for receiving the speech information and an interface for transmitting the speech information may be different from each other, and, as a specific example, there may be a case where a telephone line is used for receiving the speech information, and an Internet line is used for transmitting the speech information.

As above, basically, the interface unit is accessed from general public and realizes a market creating function for enabling the registration of speech and the use of the speech. In other words, speech is traded like a product by the interface unit, and speech information that has not widely been a target for a transaction until now can be freely sold by anyone as a product and be purchased as a product.

The “speech input reception unit” has a function for receiving an input of speech used for generating a speech dictionary set from an external terminal through the interface unit. Here, more specifically, “receiving an input of speech used for generating a speech dictionary set from an external terminal” represents converting speech output from a user through a microphone, a telephone, or the like belonging to the external terminal from analog to digital and receiving the converted speech as a digital signal.

The “speech used for generating a speech dictionary set” represents the speech of a phrase that is a source material used for generating a speech dictionary. It is commonly known that in order to generate a speech dictionary set, it is necessary to listen to speech and extract and generate a model of speaker's phoneme and rhythm that are peculiar to the speech data of the speaker. The rhythm model is information that is acquired through a speaker reading various words and sentences. Accordingly, the “phrase that is a source material used for generating a speech dictionary” may be considered as words or sentences that are necessary for acquiring a rhythm model in addition to speech data. It is preferable that a speech dictionary set include a rhythm model and speech data relating to words or sentences that are used commonly and frequently. Accordingly, it is preferable that the above-described phrase be a word or a sentence that is used regularly and frequently. Examples of the phrase include the names of an advanced country, major city names, prefecture names, names of public figures and entertainers, general nouns, and greetings sentences. Here, all such words and phrases are examples, and a specific phrase to be used can be appropriately set. For example, in a case where a speech dictionary set corresponding to only technical words or sentences in a specific academic field is to be generated, a technical term in the academic field or like may be a phrase that is a source material although it is not a general noun or the like.

The “input of speech” represents speaker's reading speech of a phrase that is a source material. In order to generate a speech dictionary having a certain degree of accuracy or higher, reading speech of at least several tens of minutes is necessary, which is common general technical knowledge, and accordingly, it is necessary for a speaker to read a phrase that is a source material for at least several tens of minutes. Here, the speaker's reading of a phrase does not need to be completed once from the start to the end. Thus, the reading may be stopped in the middle of the process, or a text corresponding to a necessary time may be divided to be read for a plurality of times. As above, in a case where the reading time is divided into a plurality of parts, a speech dictionary set maintaining unit to be described later maintains an incomplete speech dictionary set generated based on speech read at each stopped time point.

The “registration information reception unit” has a function for receiving registration information relating to a speech owner who is a person inputting speech from an external terminal through the interface unit. More specifically, the “registration information relating to a speech owner” is unique information that specifies the speech owner or is a determination element at the time of recognizing characteristics of the speech. As the registration information, for example, sex, age, a public figure having a similar sound, a facial picture, a speech dictionary ID used on a network, a name, an address, occupation, a telephone number, a credit card number, a bank account number, or the like may be considered. By receiving the information, a user can easily select a speech dictionary satisfying desired conditions by associating a speech dictionary set and registration information with each other. More specifically, for example, this represents that the registration of information is received such that a speech dictionary satisfying a condition such as “a male in his twenties”, a “female of a career woman style in her thirties”, “resembling the current prime minister”, or “resembling the voice of a character of an animation having high television ratings” can be searched.

In addition, a configuration may be considered in which a speech dictionary set is provided at a cost, and, a monetary profit is distributed to a speaker of speech included in the speech dictionary set in accordance with the number of times of user's selection of the speech dictionary set. The price of a speech dictionary set may be determined by a speaker as the registration information or may be determined by a server supervisor. In addition, in order to efficiently distribute the monetary profit, a configuration may be employed in which information such as a name or a bank account number is registered as the registration information.

In addition, various kinds of information may be considered as the registration information, and information that is undesirable to be open to the public because of its personal nature may be included therein. Accordingly, when the registration information is input, it is preferable to employ a configuration in which information to be open to the public and information not to be open to the public can be selected by the speaker.

The “speech dictionary set maintaining unit” has a function for maintaining a speech dictionary set generated based on the speech of which the input is received in association with the registration information relating to a person inputting the speech. The “speech dictionary set generated based on the speech” represents a speech dictionary set that extracts and generates speech data and a phoneme and rhythm model from the information of speech read by the speaker and can provide speech information corresponding to an arbitrary text. More specifically, a function for aggregating and maintaining information of characteristics such as the speed, the position of an accent, the magnitude and the height of the sound of the speaking style for each word or sentence of a speaker in units of speakers is included therein.

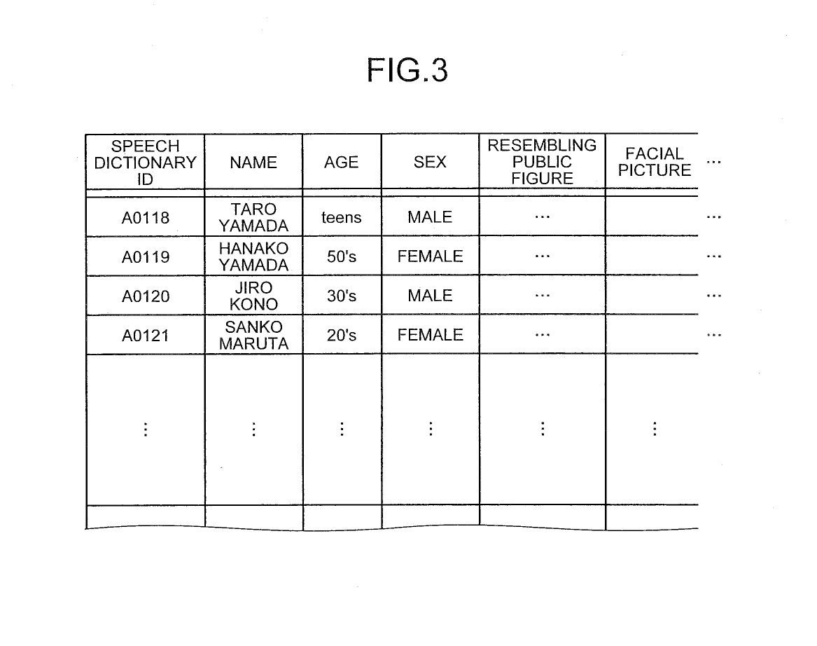

The “maintaining a speech dictionary set in association with registration information relating to a person inputting the speech” represents that one or a plurality of pieces of registration information input by a speaker who is the person inputting the speech and a speech dictionary set are maintained with being tied up with each other. FIG. 3 is a diagram that illustrates an example of a method of maintaining speech dictionary sets in the speech dictionary set maintaining unit of the server apparatus according to this embodiment. As illustrated in the figure, by employing a configuration in which a plurality of pieces of registration information are maintained in a table form with being associated with each other for each speech dictionary set, a user can search for registration information corresponding to conditions characterizing synthesized speech requested from himself/herself, whereby a speech dictionary set approximating to the conditions can be selected.

The “speech dictionary set selecting unit” has a function for configuring speech dictionary sets maintained in the speech dictionary set maintaining unit to be selectable from an external terminal through the interface unit. Here, “configuring speech dictionary sets to be selectable” “from an external terminal through the interface unit” represents that a presentation unit is used which enables a user using the external terminal to select a speech dictionary set appropriate to his/her desired conditions. For the “presentation unit enabling the user to select a speech dictionary set appropriate to his/her desired conditions”, for example, a method may be considered in which an input of conditions is received from the user, and information of a speech dictionary set associated with registration information of which the content matches the conditions is displayed and output through the interface unit. In addition, a method may be considered in which registration information of a speech dictionary set selected by the user in the past is stored together with a user ID, and a speech dictionary set having information similar to the registration information is displayed and output so as to be preferentially visible to the user. Furthermore, a method may be considered in which the information of each speech dictionary set is open to the public through the interface unit in a state in which speech data for reproduction can be output, and, by reproducing the speech data for reproduction in accordance with a user's selection, it is checked whether or not the speech data satisfies his/her desired conditions. As the speech data for reproduction, for example, a method may be used in which typical speech data recorded in the server in advance is reproduced, or it may be configured such that an input of a reading text to be described later is received from the user, and the reading text is reproduced as synthesized speech. In addition, a configuration may be employed in which a speaker other than the user registers a reading text for reproduction, and the reading text is reproduced as synthetic speech.

Furthermore, in a case where a user's selection is received by the speech dictionary set selecting unit, the selected speech dictionary set may be downloaded to a user-side external terminal or may be maintained in the server apparatus as before, and a method may be used in which the speech dictionary set is appropriately used for speech synthesis in accordance with a user's output command issued thereafter.

### Specific Configuration of Server Apparatus

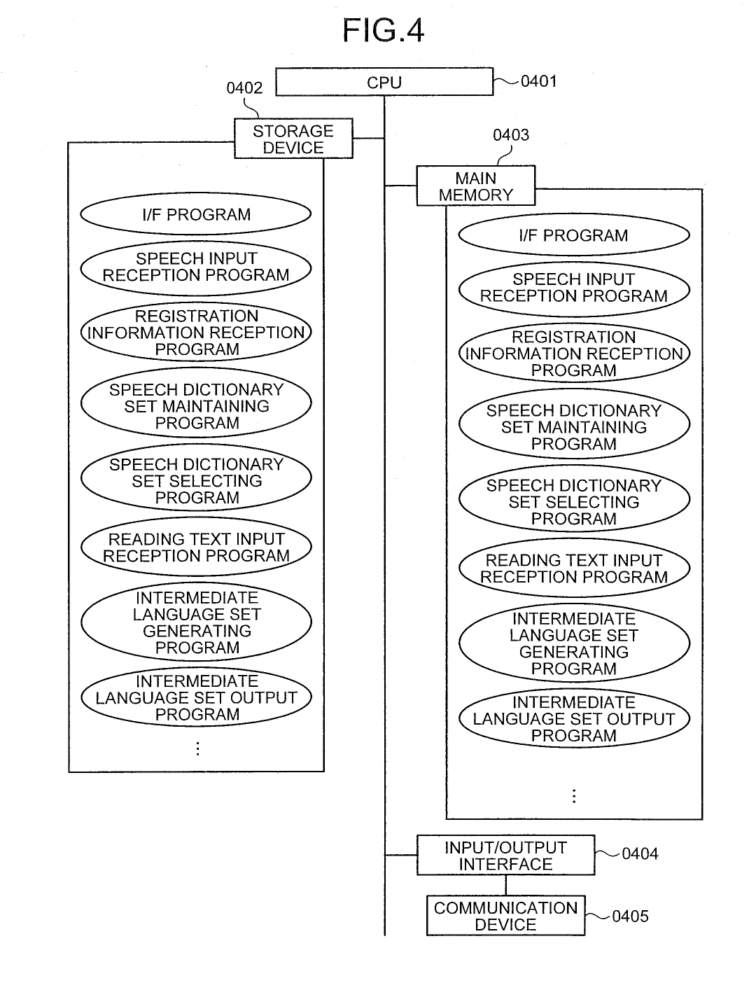

FIG. 4 is a schematic diagram that illustrates an example of the hardware configuration in a case where each functional configuration of the server apparatus is implemented by a computer. The functions of each hardware configuration unit will be described with reference to the figure.

As illustrated in the figure, the server apparatus includes a “CPU” 0401 used for performing a calculation process in each unit, a “storage device (storage medium)” 0402, a “main memory” 0403, and an “input/output interface” 0404 and performs input/output of information from/to an “external terminal (communication device)” 0405 such as a speech synthesis terminal via a network through an input/output interface. The above-described configurations are interconnected through a data communication path such as a “system bus” and performs transmission/reception of information and processes.

### Specific Process of Interface Unit

By executing an “interface (I/F) program”, the CPU performs a process of configuring an interface for opening the speech input reception unit, the speech dictionary set selecting unit, and the like to the public on a network for external terminals.

### Specific Process of Speech Input Reception Unit

By executing a “speech input reception program”, the CPU performs a process of acquiring speech information of a speaker from an external terminal through the interface and stores the information at a predetermined address in the main memory. Here, the speech information is acquired as a digital signal that is converted from analog to digital in the external terminal device. When an input time of the speech information is less than a time designated in advance, the speech information until that time point is stored at a predetermined address in the storage device. Then, when the input of the speech information is resumed, the incomplete speech information is read from the predetermined address in the storage device and the input of the speech information is additionally received.

### Specific Process of Registration Information Reception Unit

By executing a “registration information reception program”, the CPU performs a process of receiving registration information output from the external terminal through the interface and stores the information at a predetermined address in the main memory.

### Specific Process of Speech Dictionary Set Maintaining Unit

By executing a “speech dictionary set maintaining program”, the CPU reads the speech information and the registration information stored at predetermined addresses, performs a process of extracting a rhythm model and speech data from the information, and stores information acquired by the process and the registration information at a predetermined address in the main memory as a speech dictionary set.

### Specific Process of Speech Dictionary Set Selecting Unit

By executing a “speech dictionary set selecting program”, the CPU performs a process of selecting a speech dictionary set matching the content of an instruction from among a plurality of maintained speech dictionary sets based on the instruction made from an external terminal through the interface and stores a result of the process at a predetermined address in the main memory.

### Flow of Process

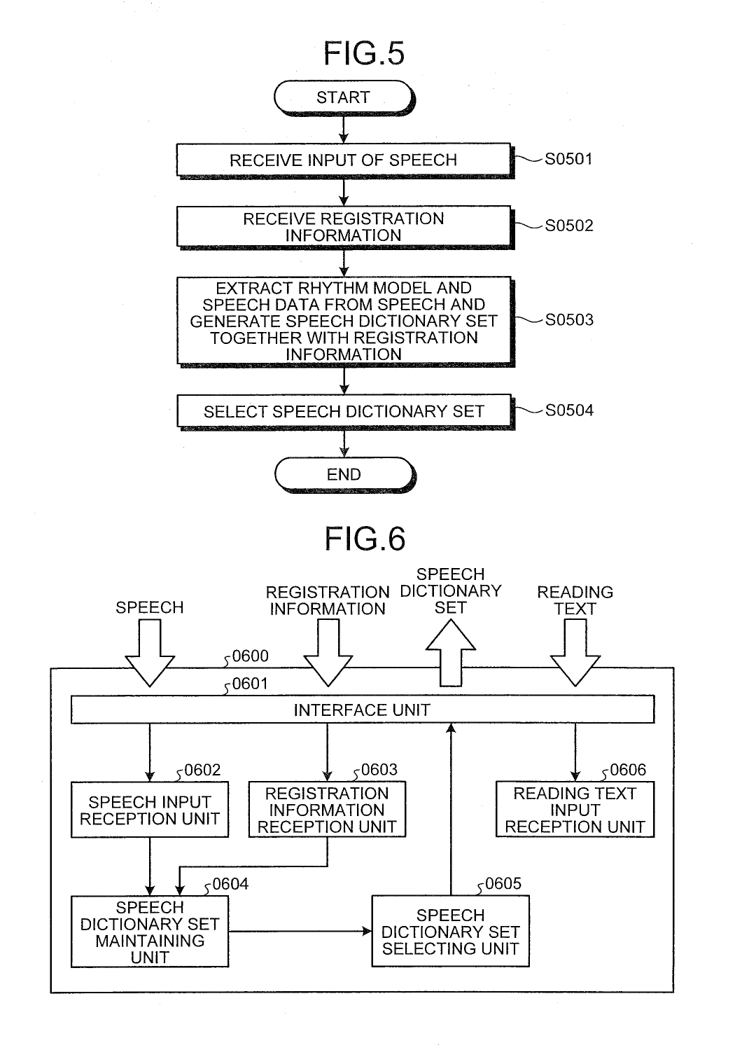

FIG. 5 is a diagram that illustrates an example of the flow of the control process of the server apparatus according to this embodiment. The flow of the process illustrated in the figure is configured by the following steps. First, in Step S0501, an input of speech is received. Next, in Step S0502, an input of registration information is received. Next, in Step S0503, a rhythm model and speech data are extracted from the speech of which the input has been received, and a speech dictionary set is generated together with registration information. Next, in Step S0504, a speech dictionary set is selected based on an instruction provided from an external terminal. Here, the processing sequence of Steps S0501 and S0502 may be reversed.

### Advantages

According to the speech synthesis system including the server apparatus of this embodiment, a user can freely accumulate a speech dictionary set, which is based on his or her speech model, in a server and open the speech dictionary set to the public. In addition, since the speech dictionary set can be open to the public in a simple manner as described above, the opening of many speech dictionary sets is urged, and, as a result, a speech dictionary set according to the conditions requested from the user can be provided.

### Second Embodiment

### Overview

While a speech synthesis system according to this embodiment is basically the same as the speech synthesis system according to the first embodiment, the server apparatus further includes a function for receiving an input of a reading text through the interface unit. By employing the configuration of this embodiment having such a feature, speech having a content acquired by reading an arbitrary text requested from a user can be synthesized.

Functional. Configuration

FIG. 6 is a diagram that illustrates an example of functional blocks of a server apparatus of the speech synthesis system according to this embodiment. As illustrated in this figure, the “server apparatus” 0600 of the “speech synthesis system” according to this embodiment is configured by an “interface unit” 0601, a “speech input reception unit” 0602, a “registration information reception unit” 0603, a “speech dictionary set maintaining unit” 0604, a “speech dictionary set selecting unit” 0605, and a “reading text input reception unit” 0606. Since the basic configuration is common to the server apparatus of the speech synthesis system according to the first embodiment described with reference to FIG. 2, hereinafter, the “reading text input reception unit”, which is a different point, will be described.

The “reading text input reception unit” has a function for receiving an input of a reading text through the interface unit. The “reading text” represents a text to be read using synthesized speech to be described later. Although the text is considered to be text information, it may be speech information. In a case where an input of a reading text is received as speech information, in order to accurately recognize the content of the speech information, it is necessary that a speech recognizing device maintaining a word dictionary covering a broad range of vocabularies and a speech dictionary having a language model should be included inside the server apparatus.

In addition, for inputting a reading text, in addition to a method in which a user inputs a word or a sentence that is a text by operating an input device such as a keyboard, a method of inputting a URL that is a recording destination of a text having a specific content may be used. By using the latter method, the user can input a large amount of texts without having efforts for inputting individual sentences.

Furthermore, when an input of a reading text is received, a configuration may be employed in which the selection of a plurality of mutually-different speech dictionary sets is received. By employing such a configuration, a case where a plurality of synthesized speeches is necessary such as the case of a chatting application in which a plurality of users are participated or an electronic book application having a content in which a plurality of characters appears can be responded as well.

### Specific Configuration of Server Apparatus

The hardware configuration of the server apparatus configuring the speech synthesis system according to this embodiment is basically the same as that of the server apparatus according to the first embodiment described with reference to FIG. 4. Hereinafter, a specific process of the reading text input reception unit, which has not been described in the first embodiment, will be described.

### Specific Process of Reading Text Input Reception Unit

By executing a “reading text input reception program”, the CPU performs a process of receiving an input of a reading text through the interface and stores a result thereof at a predetermined address in the main memory.

### Flow of Process

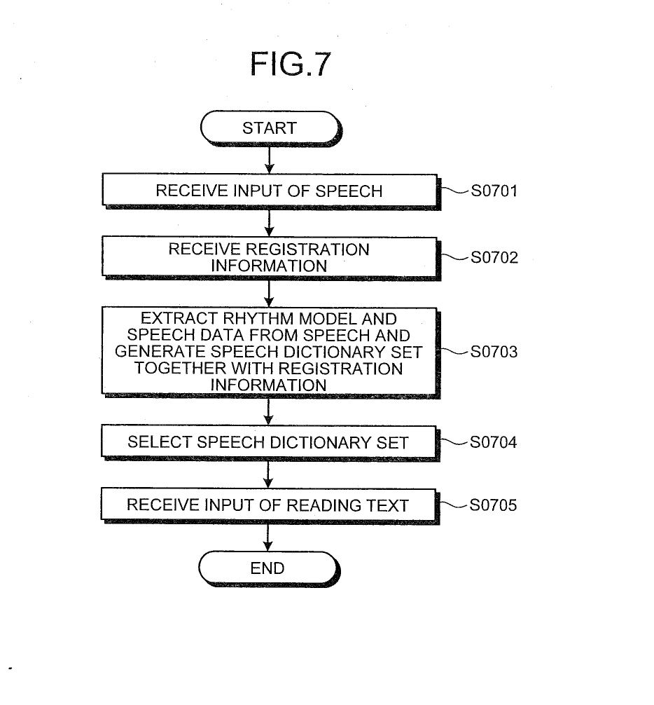

FIG. 7 is a diagram that illustrates an example of the process flow of the server apparatus configuring the speech synthesis system according to this embodiment. The flow of the process illustrated in the figure is configured by the following steps. First, in Step S0701, an input of speech is received. Next, in Step S0702, an input of registration information is received. Next, in Step S0703, a rhythm model and speech data are extracted from the speech of which the input has been received, and a speech dictionary set is generated together with registration information. Next, in Step S0704, a speech dictionary set is selected based on an instruction provided from an external terminal. Thereafter, in Step S0705, an input of a reading text is received. Here, the processing sequence of Steps S0701 and S0702 may be reversed.

### Advantages

According to the speech synthesis system including the server apparatus of this embodiment, a user can synthesize speech having a content acquired by reading an arbitrary text requested from a user.

### Third Embodiment

### Overview

While a speech synthesis system according to this embodiment is basically the same as the speech synthesis system according to the first embodiment, the reading text input reception unit maintains a first prohibited text list that is a list of texts to be processed to be prohibited, compares an input reading text and the prohibited text list with each other, and performs a prohibition process for not allowing the prohibited text to be used for speech synthesis. By employing the configuration of this embodiment having such a feature, speech synthesis having a content that is contrary to public order or morality is prevented in advance, and accordingly, synthesized speech can be prevented from being used in a crime, mischief, or the like against speaker's intention.

### Functional Configuration

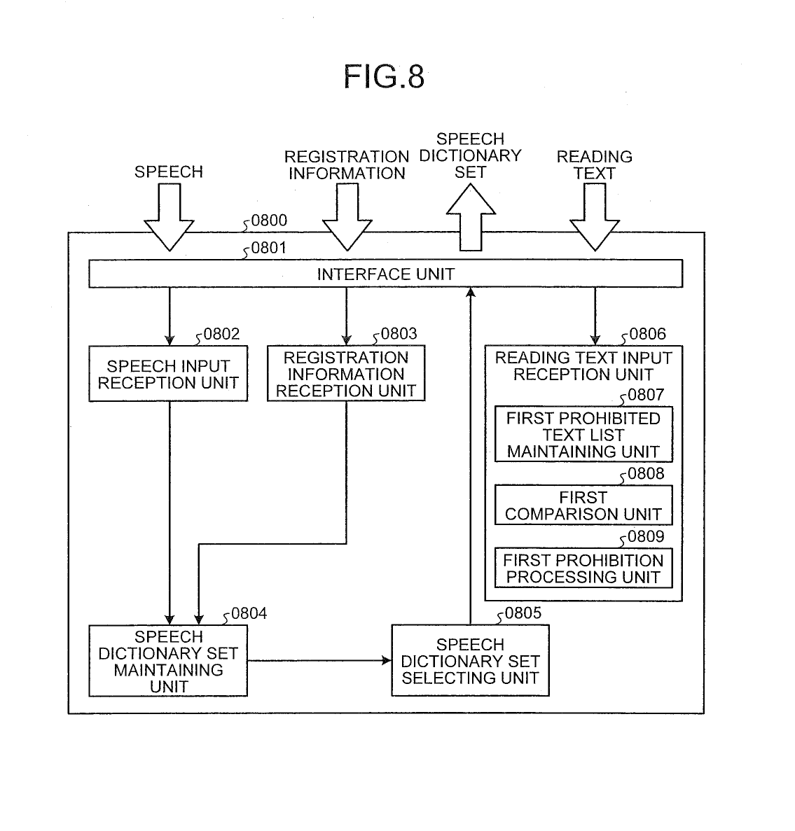

FIG. 8 is a diagram that illustrates an example of functional blocks of the server apparatus according to this embodiment. As illustrated in this figure, the “server apparatus” 0800 of the “speech synthesis system” according to this embodiment is configured by an “interface unit” 0801, a “speech input reception unit” 0802, a “registration information reception unit” 0803, a “speech dictionary set maintaining unit” 0804, a “speech dictionary set selecting unit” 0805, and a “reading text input reception unit” 0806. The reading text input reception unit further includes a “first prohibited text list maintaining unit” 0807, “first comparison unit” 0808, and a “first prohibition processing unit” 0809. Since the basic configuration is common to the server apparatus of the speech synthesis system according to the second embodiment described with reference to FIG. 6, hereinafter, the “first prohibited text list maintaining unit”, the “first comparison unit”, and the “first prohibition processing unit”, which are different points, will be described.

The “first prohibited text list maintaining unit” has a function for maintaining a first prohibited text list that is a list of texts to be processed to be prohibited. The “texts to be processed to be prohibited” represents texts such as a text having a content that is contrary to public order or morality and a text having a content against speaker's intention that are considered to be undesirable to be output to be open to the public. More specifically, a text in which a word reminding a specific criminal behavior such as “kidnapping” or a “ransom” is included, a text in which a word having a content representing slander is included, a text having a context discrediting the dignity of the speaker, or the like may be considered.

For the configuration of the first prohibited text list, a method may be considered in which a plurality of texts considered to be generally prohibited are recorded in advance. The texts to be prohibited may change in accordance with social conditions and the like, and it is preferable to employ a configuration of the first prohibited list in which texts can be added, deleted, or corrected at any time by a server supervisor.

In addition, as the first prohibited text list, one integrated list may be present in the speech synthesis system, an individual first prohibited text list may be present for each speech dictionary, or an integrated list and an individual list for each speech dictionary may be present together. Here, the individual list for each speech dictionary may be considered to have a configuration in which the individual list can be generated and edited by a speaker who has provided the information of the speech dictionary. By employing such a configuration, not only the synthesis of speech such as a crime that cannot be generally allowed in the society can be prevented in advance, but also the synthesis of speech that is desired not to be output by a speaker due to no matching his or her image or the like can be prohibited in advance.

The “first comparison unit” has a function for comparing an input reading text and the first prohibited text list with each other. Here, the “comparing of an input reading text and the first prohibited text list with each other” represents checking whether or not there is a prohibited text, which is included in the first prohibited text list, is included in the content of the reading text. By employing such a configuration, a text having a content for which a speech synthesis process is not to be performed can be recognized in a previous stage of the synthesis process, and accordingly, the labor of performing the subsequent process can be prevented in advance, whereby a mechanical load applied to the server apparatus can be reduced.

The “first prohibition processing unit” has a function for performing a prohibition process for not using a prohibited text in speech synthesis in accordance with a result of the comparison. The “not using a prohibited text in speech synthesis in accordance with a result of the comparison” represents that, in a case where a text registered in the first prohibited text list as a prohibited text is checked to haven been input as the result of the comparison, speech synthesis for the text is not performed in accordance with the read content.

Here, the “prohibited text” is a reading text determined to be processed to be prohibited out of the reading texts. Other than a configuration in which the whole reading text is set as a prohibited text, a configuration may be considered in which only a part of the text that is included in the first prohibited text list out of the reading text is set as a prohibited text. In other words, the “not performing of speech synthesis in accordance with the content of the read text” may represent a configuration in which speech synthesis of only the part determined as a prohibited text is not performed, a configuration in which speech synthesis of the whole reading text including the content determined as a prohibited text is not performed, or a configuration in which the above-described configurations are maintained to be selectable.

### Specific Configuration of Server Apparatus

The hardware configuration of the server apparatus configuring the speech synthesis system according to this embodiment is basically the same as that of the server apparatus according to the second embodiment described with reference to FIG. 4. Hereinafter, specific processes of the first prohibited text list maintaining unit, the first comparison unit, and the first prohibition processing unit, which have not been described in the second embodiment, will be described.

### Specific Process of First Prohibited Text List Maintaining Unit

By executing a “first prohibited text list maintaining program”, the CPU performs a process of storing information of the first prohibited text list that is a list of texts including contents to be processed to be prohibited, which will be described later, at a predetermined address an the main memory.

### Specific Process of First Comparison Unit

By executing a “first comparison program”, the CPU reads the first prohibited text list stored at a predetermined address in the main memory and a reading text together and performs a process of comparing contents of the information. Then, the CPU stores a result of the process at a predetermined address in the main memory.

### Specific Process of First Prohibition Processing Unit

By executing a “first prohibition processing program”, the CPU performs a filtering process for not using the prohibited text in the speech synthesis in accordance with the result of the comparison acquired by the process performed by the first comparison unit and stores a result thereof at a predetermined address in the main memory.

### Flow of Process

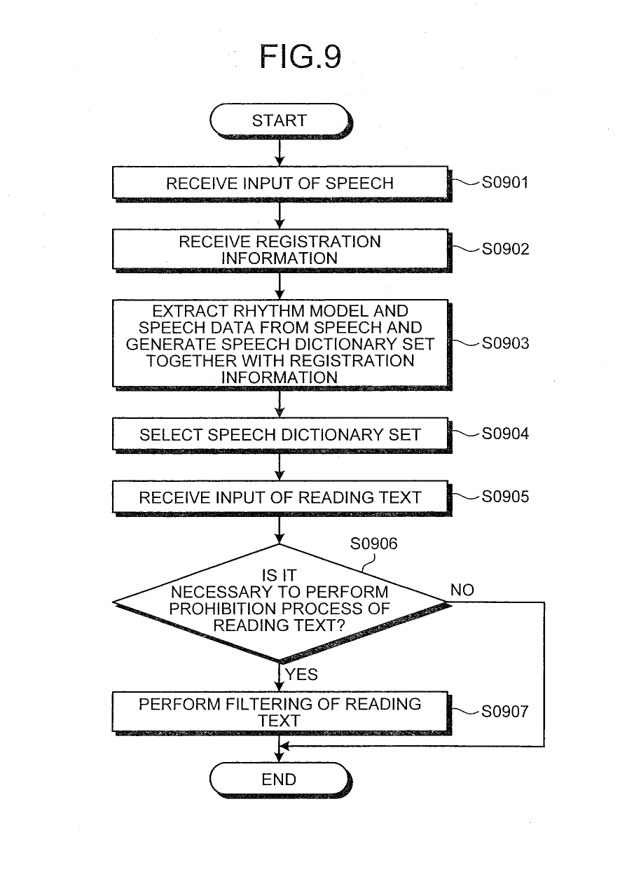

FIG. 9 is a diagram that illustrates an example of the flow of the control process of the server apparatus configuring the speech synthesis system according to this embodiment. The flow of the process illustrated in the figure is configured by the following steps. First, in Step S0901, an input of speech is received. Next, in Step S0902, an input of registration information is received. Next, in Step S0903, a rhythm model and speech data are extracted from the speech of which the input has been received, and a speech dictionary set is generated together with registration information. Next, in Step S0904, a speech dictionary set is selected based on an instruction provided from an external terminal. Thereafter, in Step S0905, an input of a reading text is received. Next, in Step S0906, it is determined whether or not to perform a prohibition process of the input reading text is necessary. In a case where it is determined that to perform the prohibition process is necessary, the process proceeds to Step S0907. On the other hand, in a case where it is determined that to perform the prohibition process is not necessary, the process ends. Then, in Step S0907, a filtering process for not using the prohibited text in the speech synthesis is performed. Here, the processing sequence of Steps S0901 and S0902 may be reversed.

### Advantages

According to the speech synthesis system including the server apparatus of this embodiment, speech synthesis having a content that is contrary to public order or morality is prevented in advance, and accordingly, synthesized speech can be prevented from being used in a crime, mischief, or the like against speaker's intention.

### Fourth Embodiment

### Overview

While a speech synthesis system according to this embodiment is basically the same as the speech synthesis system according to the second embodiment, the server apparatus has a feature of generating an intermediate language set used for speech synthesis using a speech dictionary set based on the reading text. By employing such a configuration of this embodiment having such a feature, speech synthesis of words that are newly generated day by day can be generated.

### Functional Configuration

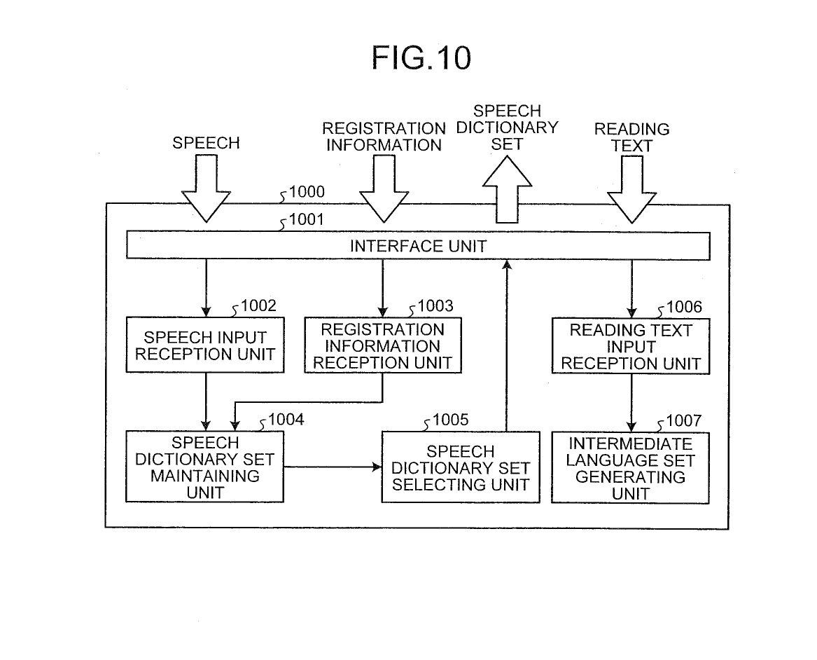

FIG. 10 is a diagram that illustrates an example of functional blocks of the server apparatus of the speech synthesis system according to this embodiment. As illustrated in this figure, a “server apparatus” 1000 of the “speech synthesis system” according to this embodiment is configured by an “interface unit” 1001, a “speech input reception unit” 1002, a “registration information reception unit” 1003, a “speech dictionary set maintaining unit” 1004, a “speech dictionary set selecting unit” 1005, a “reading text input reception unit” 1006, and an “intermediate language set generating unit” 1007. Since the basic configuration is common to the server apparatus of the speech synthesis system according to the second embodiment described with reference to FIG. 6, hereinafter, the “intermediate language set generating unit”, which is a different point, will be described.

The “intermediate language set generating unit” has a function for generating an intermediate language set used for speech synthesis using a speech dictionary set based on the reading text. The “generating an intermediate language set used for speech synthesis using a speech dictionary set based on the reading text”, in short, represents generating an intermediate language set having a, content that is based on a reading text of which the input has been received by the reading text input reception unit. More specifically, it represents generating an intermediate language set that is a technology relating to controlling a method of analyzing a content of the reading text and performing reading based on the content of the analysis. More specifically, a process is performed in which a text is divided into single segments or words, an appropriate reading way is specified by distinguishing Chinese/Japanese reading of a Chinese character, homonyms, and the like, a rhythm of each word, a phrase interval between segments, and the like are set.

As above, there is a position at which reading Chinese character or the analysis of the accent of a word needs to be performed for the intermediate language set, and generally, words are changed and newly generated frequently day by day. For example, there are cases where a word that has not been used by anybody and has not been general such as a new word, a vogue word, a name of a new entertainer who has lately debuted, or a name of a newly established company instantly becomes general. Thus, in order to appropriately form a reading text as an intermediate language set, a program to be described later that is the premise of the generation of the intermediate language set needs to be updated in detail so as to respond to a change in the manner in which such a word is used. In an embodiment in which the intermediate language set generating unit is a constituent element of the server apparatus, the program used for generating the intermediate language set can be expected to be updated at appropriate timing by the server supervisor, and the inconvenience of sequentially performing updates by individual users can be resolved.

### Specific Configuration of Server Apparatus

The hardware configuration of the server apparatus configuring the speech synthesis system according to this embodiment is basically the same as that of the server apparatus according to the second embodiment described with reference to FIG. 4. Hereinafter, a specific process of the intermediate language set generating unit not described in the second embodiment will be described.

### Specific Process of Intermediate Language Set Generating Unit

By executing an “intermediate language set generating program”, the CPU reads a reading text stored in the main memory, performs a process of generating an intermediate language set having a content corresponding to the text, and stores a result thereof at a predetermined address in the main memory.

### Flow of Process

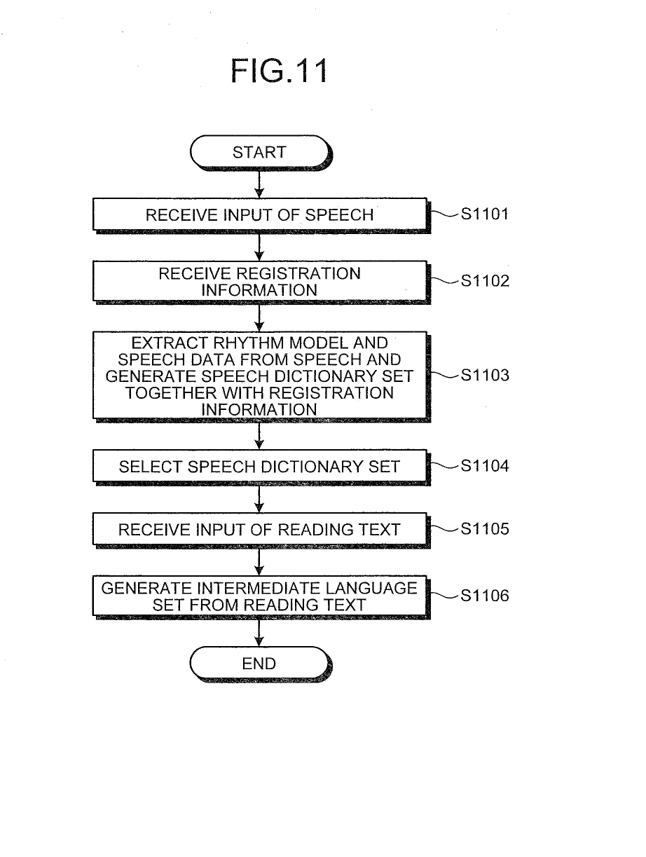

FIG. 11 is a diagram that illustrates an example of the flow of the control process of the server apparatus configuring the speech synthesis system according to this embodiment. The flow of the process illustrated in the figure is configured by the following steps. First, in Step S1101, an input of speech is received. Next, in Step S1102, an input of registration information is received. Next, in Step S1103, a rhythm model and speech data are extracted from the speech of which the input has been received, and a speech dictionary set is generated together with registration information. Next, in Step S1104, a speech dictionary set is selected based on an instruction provided from an external terminal. Thereafter, in Step S1105, an input of a reading text is received. Next, in Step S1106, a process of generating an intermediate language set based on the input reading text is performed. Here, the processing sequence of Steps S1201 and S1202 may be reversed.

### Advantages

According to the speech synthesis system including the server apparatus of this embodiment, synthesized speech corresponding to new words newly generated day by day and words changing in the meaning and intonation can be generated.

### Fifth Embodiment

### Overview

While a speech synthesis system according to this embodiment is basically the same as the speech synthesis system according to the fourth embodiment, the intermediate language set generating unit maintains a second prohibited text list that is a list of texts to be processed to be prohibited, compares a reading text used for generating an intermediate language set and the second prohibited text list with each other, and performs a prohibition process for not using the prohibited text in the speech synthesis in accordance with a result of the comparison. By employing such a configuration of this embodiment having such a feature, the process of prohibiting synthesis of speech can be performed when a text is analyzed, and accordingly, an appropriate prohibition process at the time of analyzing a text, which can be changed at any time, can be performed.

### Functional Configuration

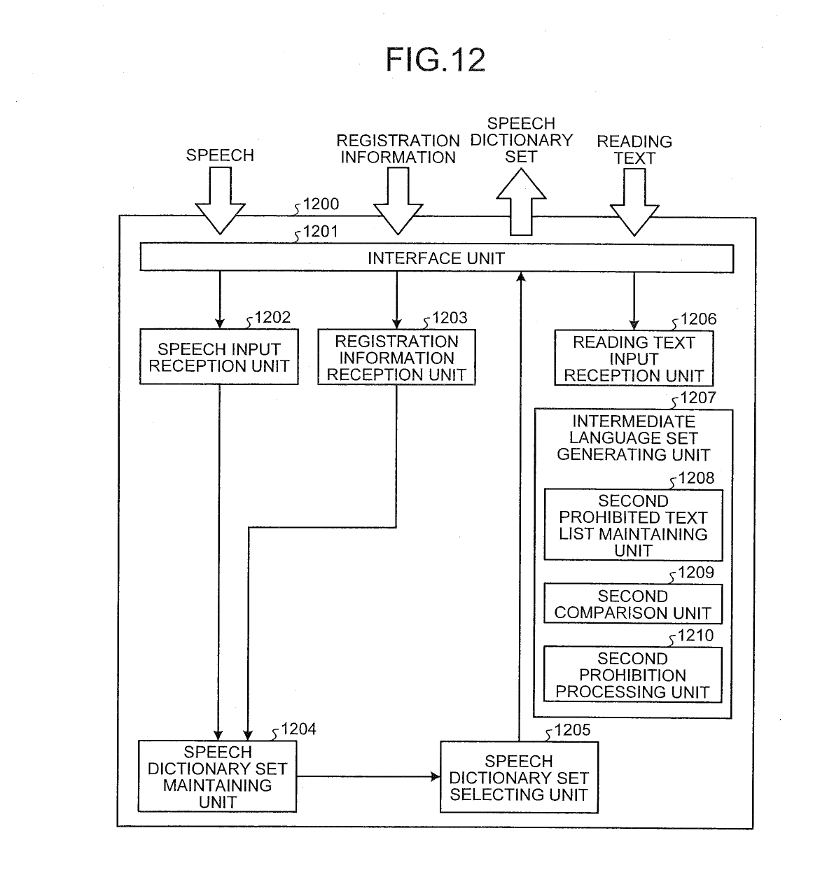

FIG. 12 is a diagram that illustrates an example of functional blocks of the server apparatus of the speech synthesis system according to this embodiment. As illustrated in this figure, the “server apparatus” 1200 of the “speech synthesis system” according to this embodiment is configured by an “interface unit” 1201, a “speech input reception unit” 1202, a “registration information reception unit” 1203, a “speech dictionary set maintaining unit” 1204, a “speech dictionary set selecting unit” 1205, a “reading text input reception unit” 1206, and an “intermediate language set generating unit” 1207. The “intermediate language set generating unit” includes a “second prohibited text list maintaining unit” 1208, a “second comparison unit” 1209, and a “second prohibition processing unit” 1210. Since the basic configuration is common to the server apparatus of the speech synthesis system according to the fourth embodiment described with reference to FIG. 9, hereinafter, the “second prohibited text list maintaining unit”, the “second comparison unit”, and the “second prohibition processing unit”, which are different points, will be described.

The “second prohibited text list maintaining unit” has a function for maintaining a second prohibited text list that is a list of texts to be processed to be prohibited. While the overview of the second prohibited text list is the same as that of the first prohibited text list described above, the second prohibited text list is different from the first prohibited text list in that the prohibited text list is configured by using an intermediate language. By employing such a configuration, the accuracy of the process in the prohibition processing unit to be described later that is higher, than that of the case of the third embodiment can be achieved.

The “second comparison unit” has a function for comparing the reading text used for generating the intermediate language set and the second text list with each other. The function of the second comparison unit is similar to that of the first comparison unit described above. However, in the second comparison unit, the above-described comparison is performed when the text analysis of the reading text is performed. In the configuration in which comparison is performed at the time of receiving a reading text, even a word, which has one reading way, has various representation ways such as a Chinese character representation and a Japanese representation, and accordingly, there is concern that a text, which is a text to be originally processed to be prohibited, is determined not to be processed to be prohibited depending on the configuration of the prohibited text list. In the second comparison unit, a text analysis is performed, and homonyms and the like can be distinguished from each other based on the way of reading the text and the accent. Accordingly, even when a word having the same meaning is represented as a Chinese character and a Japanese character in the reading text, these can be set as a target that is the same word without being distinguished from each other.

The “second prohibition processing unit” has a function for performing a prohibition process for not using the prohibited text in the speech synthesis in accordance with a result of the comparison performed by the second comparison unit. The overview of this function is the same as that of the first prohibition processing unit described above. By employing such a configuration, the prohibition process having high accuracy is appropriately performed even for a text having various representation ways.

### Specific Configuration of Server Apparatus

The hardware configuration of the server apparatus configuring the speech synthesis system according to this embodiment is basically the same as that of the server apparatus according to the fourth embodiment described with reference to FIG. 4. Hereinafter, specific processes of the second prohibited text list maintaining unit, the second comparison unit, and the second prohibition processing unit, which have not been described in the fourth embodiment, will be described.

### Specific Process of Second Prohibited Text List Maintaining Unit

By executing a “second prohibited text list maintaining program”, the CPU performs a process of storing information of the second prohibited text list, which is a list of texts including contents to be processed to be prohibited to be described later, at a predetermined address in the main memory.

### Specific Process of Second Comparison Unit

By executing a “second comparison program”, the CPU reads the second prohibited text list stored at a predetermined address in the main memory and a reading text that has been input together and performs a process of comparing contents of the information. Then, the CPU stores a result of the process at a predetermined address in the main memory.

### Specific Process of Second Prohibition Processing Unit

By executing a “second prohibition processing program”, the CPU performs a filtering process for not including a prohibited text in an intermediate language set to be generated in accordance with the result of the comparison acquired by the process performed by the second comparison unit and stores a result thereof at a predetermined address in the main memory.

### Flow of Process

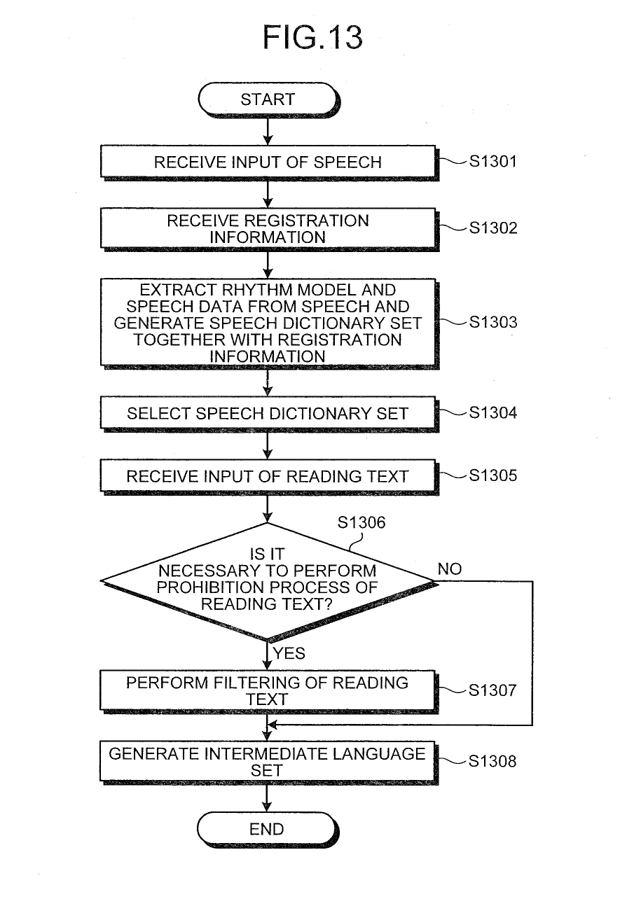

FIG. 13 is a diagram that illustrates an example of flow of the control process of the server apparatus configuring the speech synthesis system according to this embodiment. The flow of the process illustrated in the figure is configured by the following steps. First, in Step S1301, an input of speech is received. Next, in Step S1302, an input of registration information is received. Next, in Step S1303, a rhythm model and speech data are extracted from the speech of which the input has been received, and a speech dictionary set is generated together with registration information. Next, in Step S1304, a speech dictionary set is selected based on an instruction provided from an external terminal. Thereafter, in Step S1305, an input of a reading text is received. Next, in Step S1306, it is determined whether or not to perform a prohibition process of the input reading text is necessary. In a case where it is determined that to perform the prohibition process is necessary, the process proceeds to Step S1307. On the other hand, in a case where it is determined that to perform the prohibition process is not necessary, the process proceeds to Step S1308. Then, in Step S1307, a filtering process for not using the prohibited text in the speech synthesis is performed. Next, in Step S1308, a process of generating an intermediate language set based on the input reading text is performed. Here, the processing sequence of Steps S1301 and S1302 may be reversed.

### Advantages

According to the speech synthesis system including the server apparatus of this embodiment, a timely prohibition process can be performed.

### Sixth Embodiment

### Overview

While a speech synthesis system according to this embodiment is basically the same as the speech synthesis system according to the fourth embodiment, the server apparatus has a feature of outputting an intermediate language set generated through the interface unit to an external terminal. By employing such a configuration of this embodiment having such a feature, the external terminal can generate synthesized speech using the intermediate language set.

### Functional Configuration

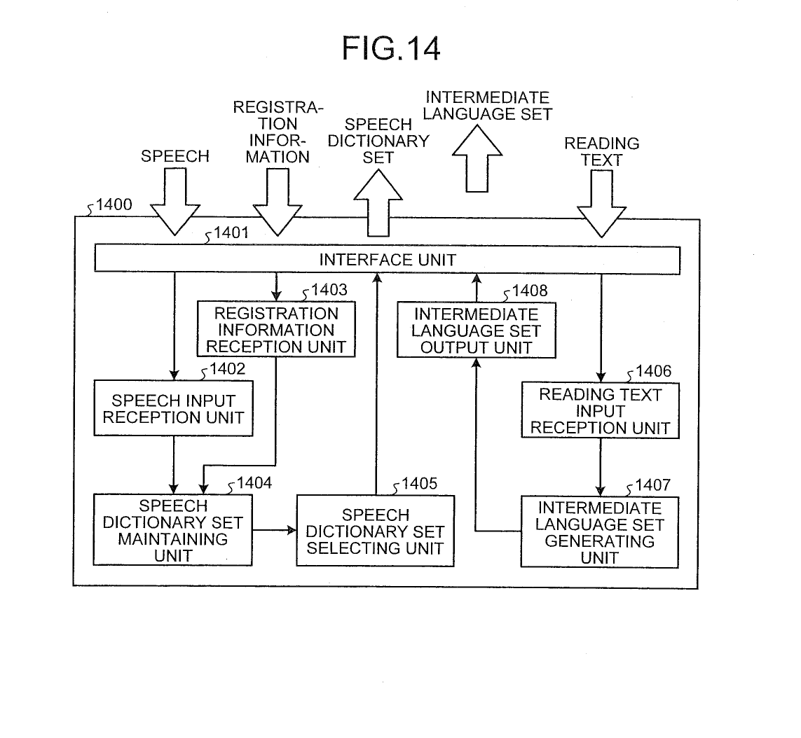

FIG. 14 is a diagram that illustrates an example of functional blocks of the server apparatus of the speech synthesis system according to this embodiment. As illustrated in this figure, a “server apparatus” 1400 of the “speech synthesis system” according to this embodiment is configured by an “interface unit” 1401, a “speech input reception unit” 1402, a “registration information reception unit” 1403, a “speech dictionary set maintaining unit” 1404, a “speech dictionary set selecting unit” 1405, a “reading text input reception unit” 1406, an “intermediate language set generating unit” 1407, and an “intermediate language set output unit” 1408. Since the basic configuration is common to the server apparatus of the speech synthesis system according to the fourth embodiment described with reference to FIG. 8, hereinafter, the “intermediate language set output unit”, which is a different point, will be described.

The “intermediate language set output unit” has a function for outputting an intermediate language set generated through the interface unit to an external terminal. For the “outputting an intermediate language set to an external terminal”, more specifically, a method of outputting the intermediate language set in a data format may be considered. In addition, a method may be used in which the intermediate language set is output to the external terminal through a streaming mode. By employing such a configuration, the external terminal can generate synthesized speech while receiving an intermediate language set corresponding to an input text at any time, and, accordingly, for example, even in a case where a short message of a text is input in a short time as in the chatting, a disadvantage of having along time until the output of the synthesized speech so as to be delayed can be prevented.

### Specific Configuration of Server Apparatus

The hardware configuration of the server apparatus configuring the speech synthesis system according to this embodiment is basically the same as that of the server apparatus according to the fourth embodiment described with reference to FIG. 4. Hereinafter, a specific process of the intermediate language set output unit not described in the fourth embodiment will be described.

### Specific Process of Intermediate Language Set Output Unit

By executing an “intermediate language set output program”, the CPU performs a process of outputting the generated intermediate language set to an external terminal through the interface.

### Flow of Process

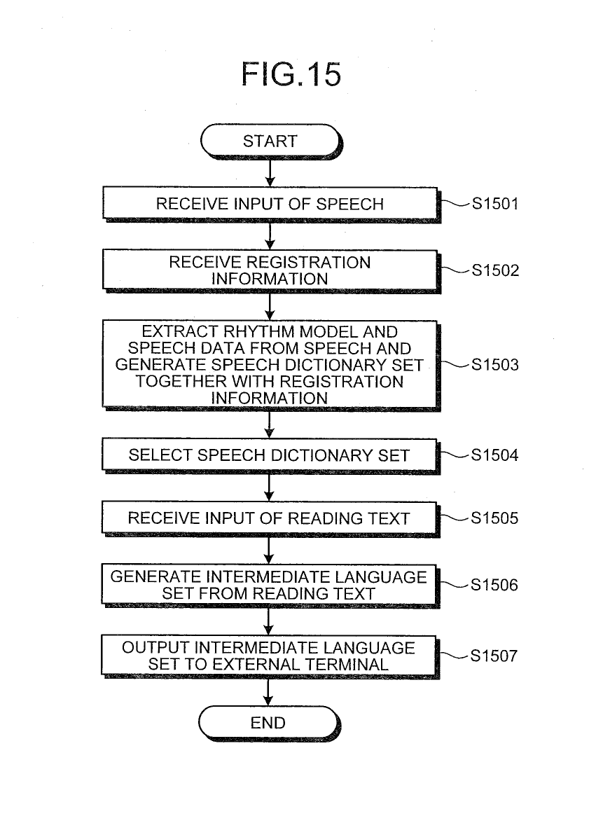

FIG. 15 is a diagram that illustrates an example of the flow of the control process of the server apparatus configuring the speech synthesis system according to this embodiment. The flow of the process illustrated in the figure is configured by the following steps. First, in Step S1501, an input of speech is received. Next, in Step S1502, an input of registration information is received. Next, in Step S1503, a rhythm model and speech data are extracted from the speech of which the input has been received, and a speech dictionary set is generated together with registration information. Next, in Step S1504, a speech dictionary set is selected based on an instruction provided from an external terminal. Thereafter, in Step S1505, an input of a reading text is received. Next, in Step S1506, a process of generating an intermediate language set based on the input reading text is performed. Next, in Step S1507, the intermediate language set is output to the external terminal. Here, the processing sequence of Steps S1501 and S1502 may be reversed.

### Advantages

According to the speech synthesis system including the server apparatus of this embodiment, the external terminal can generate synthesized speech using the intermediate language set.

### Seventh Embodiment

### Overview

While a speech synthesis system according to this embodiment is basically the same as the speech synthesis system according to the first embodiment, a speech synthesis terminal is further included which outputs a selection command used for selecting a speech dictionary set in the speech dictionary set selecting unit through the interface unit, acquires a speech dictionary set selected in accordance with the output selection command through the interface unit, and performs speech synthesis using the selected speech dictionary set. By employing such a configuration of this embodiment having such a feature, the user not only selects a speech dictionary set by operating the terminal but also performs a speech synthesis process, and the synthesized speech can be used for various kinds of applications.

### Functional Configuration

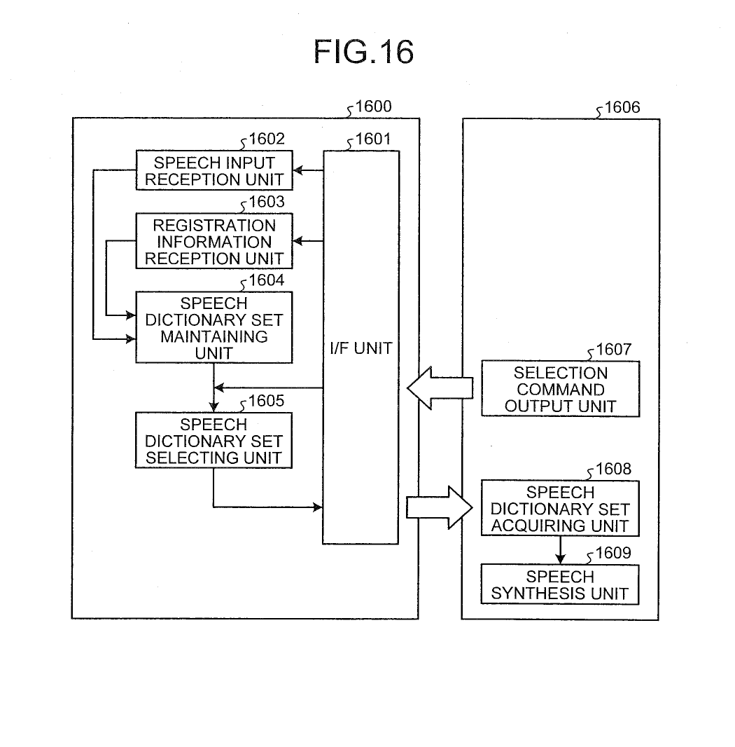

FIG. 16 is a diagram that illustrates an example of functional blocks of the speech synthesis system according to the seventh embodiment. As illustrated in FIG. 16, a “server apparatus” 1600 of the “speech synthesis system” according to the seventh embodiment is configured by an “interface (I/F) unit” 1601, a “speech input reception unit” 1602, a “registration information reception unit” 1603, a “speech dictionary set maintaining unit” 1604, and a “speech dictionary set selecting unit” 1605. The speech synthesis terminal 1606 is configured by a “selection command output unit” 1607, a “speech dictionary set acquiring unit” 1608, and a “speech synthesis unit” 1609. Since the basic configuration of the server apparatus is common to the server apparatus of the speech synthesis system according to the first embodiment described with reference to FIG. 2, hereinafter, the “speech synthesis terminal” and each unit of the speech synthesis terminal, which are different points, will be described.

The “speech synthesis terminal” is an external terminal connected to the server apparatus through a network.

The “selection command output unit” has a function for outputting a selection command used for selecting a speech dictionary set in the speech dictionary set selecting unit through the interface unit. The “selection command used for selecting a speech dictionary set in the speech dictionary set selecting unit” is information for an instruction of selecting a speech dictionary set having a content matching the conditions requested from the user from among the speech dictionary sets maintained in the server apparatus and, more specifically, represents an instruction for selecting the speech dictionary set selected by the user based on information of the age, the sex, and the entertainer having a similar sound quality, and the like described until now.

The “speech dictionary set acquiring unit” has a function for acquiring the speech dictionary set selected in accordance with the output selection command through the interface unit. By employing such a configuration, there is an advantage, which has been described in the first embodiment, that, by downloading a speech dictionary set into the external terminal in advance in a step before actual speech synthesis, a network environment from the speech synthesis to the output of the synthesized speech can be stabilized.

The “speech synthesis unit” has a function for performing speech synthesis using the selected speech dictionary set. The “performing speech synthesis using the selected speech dictionary set”, more specifically, represents a process in which a rhythm at each position of the text is predicted using the rhythm model included in, the selected speech dictionary set, a waveform at each position of the text is selected and specified using a speech database included in the speech dictionary set in the same manner, and rhythms and waveforms for each word are connected, and adjustment is performed such that the whole text is a natural sentence.

### Specific Configuration of Speech Synthesis Terminal

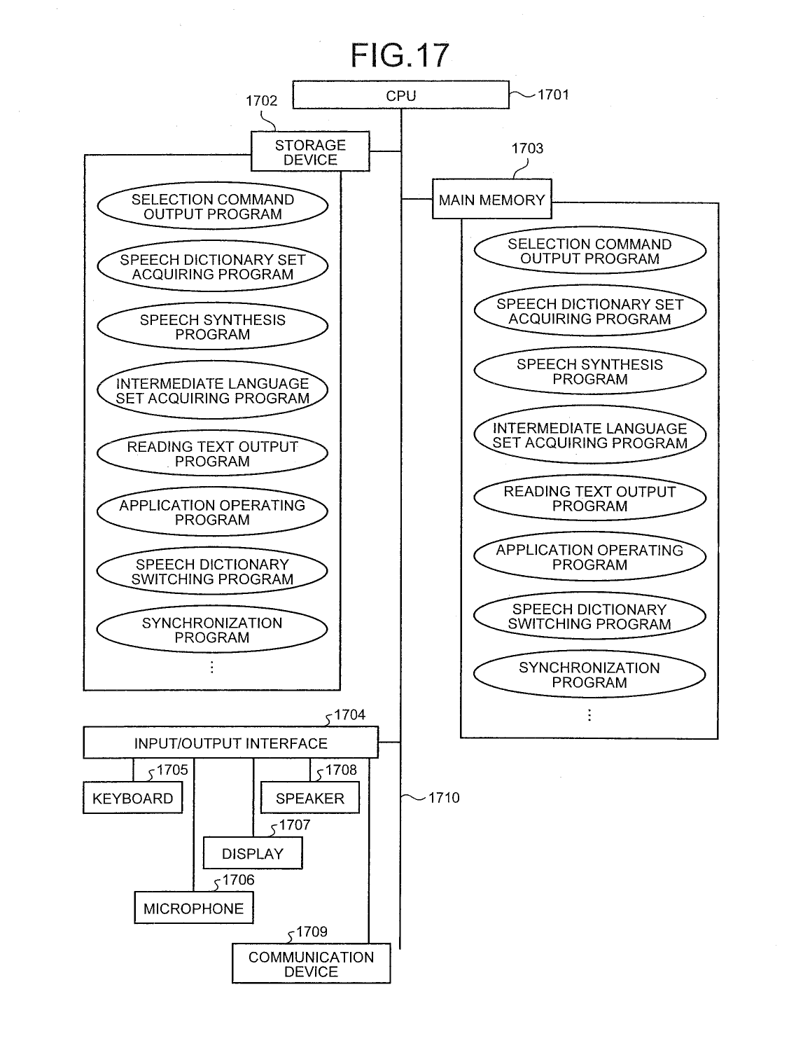

FIG. 17 is a schematic diagram that illustrates an example of the hardware configuration in a case where each functional configuration of the speech synthesis terminal is implemented by a computer. The function of each hardware configuration will be described with reference to the figure.

As illustrated in the figure, the speech synthesis terminal includes a “CPU” 1701 used for performing various calculation processes, a “storage device (storage medium)” 1702, a “main memory” 1703, and an “input/output interface” 1704. The speech synthesis terminal is connected to a “keyboard” 1705, a “microphone” 1706, a “display” 1707, a “speaker” 1708, and the like through the input/output interface and performs inputting/outputting information from/to an “external terminal (communication device)” 1709 through a network. The above-described configurations are interconnected through a data communication path such as a “system bus” 1710 and perform transmission/reception of information and processes.

### Specific Process of Selection Command Output Unit

By executing a “selection command output program”, the CPU transmits a selection command used for selecting a specific speech dictionary set from among speech dictionary sets maintained in the speech dictionary set maintaining unit of the server apparatus through a communication device.

### Specific Process of Speech Dictionary Set Acquiring Unit

By executing a “speech dictionary set acquiring program”, the CPU acquires a speech dictionary set from the server apparatus through the interface and stores the information of the speech dictionary set at a predetermined address in the main memory.

### Specific Process of Speech Synthesis Unit

The CPU reads the information of the speech dictionary set stored at a predetermined address in the main memory, executes the “speech synthesis program”, performs a process of generating synthesized speech having characteristics of the speech dictionary set, and stores a result thereof at a predetermined address in the main memory.

### Flow of Process

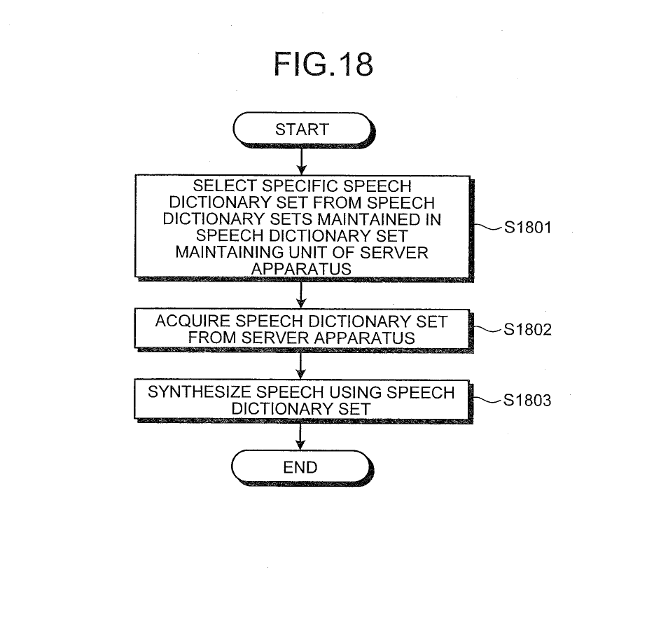

FIG. 18 is a diagram that illustrates an example of the flow of the control process of the speech synthesis terminal configuring the speech synthesis system according to the seventh embodiment. The flow of the process illustrated in the figure is configured by the following steps. First, in Step S1801, a specific dictionary set is selected from among the speech dictionary sets maintained by the speech dictionary set maintaining unit of the server apparatus. Next, in Step S1802, the speech dictionary set is acquired from the server apparatus through the interface. Next, in Step S1803, speech is synthesized by using the speech dictionary set acquired through the selection.

### Advantages

According to the speech synthesis system including the speech synthesis terminal of the seventh embodiment, a user not only can select a speech dictionary set by operating the terminal but also can perform a speech synthesis process.

### Eighth Embodiment

### Overview

While a speech synthesis system according to this embodiment is basically the same as the speech synthesis system according to the seventh embodiment, the speech synthesis terminal outputs a reading text to the reading text input reception unit through the interface unit, acquires an intermediate language set corresponding to the reading text output from the reading text output unit from the intermediate language set output unit through the interface unit, and outputs the acquired intermediate language set to the speech synthesis unit. By employing such a configuration of this embodiment having such a feature, the user can perform the process from the input of a text to the generation of synthesized speech by using the same terminal.

### Functional Configuration

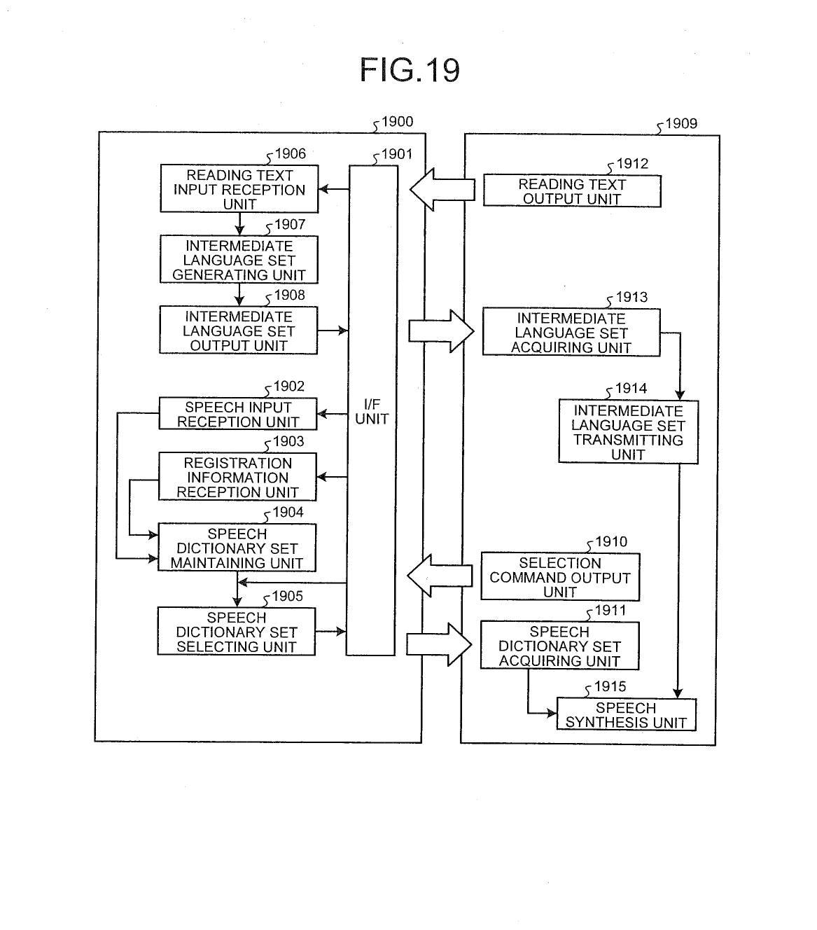

FIG. 19 is a diagram that illustrates an example of functional blocks of the speech synthesis system according to the eighth embodiment. As illustrated in FIG. 19, a “speech synthesis terminal” 1909 of the “speech synthesis system” according to the eighth embodiment is configured by a “selection command output unit” 1910, a “speech dictionary set acquiring unit” 1911, a “reading text output unit” 1912, an “intermediate language set acquiring unit” 1913, an “intermediate language set transmitting unit” 1914, and a “speech synthesis unit” 1915. Since the basic configuration of the speech synthesis terminal is mainly the same as that of the speech synthesis terminal of the speech synthesis system described in the seventh embodiment with reference to FIG. 16, hereinafter, the “reading text output unit”, the “intermediate language set acquiring unit”, and the “intermediate language set transmitting unit”, which are different points, will be described.

The “reading text output unit” has a function for outputting the reading text to the reading text input reception unit through the interface unit. The “outputting the reading text to the reading text input reception unit through the interface unit” represents that not a text maintained to have a fixed form in the server in advance but an arbitrary text output from the external terminal by the user can be used as a reading text. By employing such a configuration, in this speech synthesis system, synthesized speech having various contents requested from the user can be provided.

The “intermediate language set acquiring unit” has a function for acquiring an intermediate language set corresponding to the reading text output from the reading text output unit from the intermediate language set output unit through the interface unit. As a specific form for acquiring an intermediate language set, as presented in the description of the intermediate language set output unit according to the sixth embodiment, a method of acquiring information of the set as an intermediate language file or a method of acquiring the information of the set through streaming may be used.

The “intermediate language set transmitting unit” has a function for outputting the acquired intermediate language set to the speech synthesis unit. The usage forms of the amount of the synthesized speech that is generated, the output timing of the synthesized speech, and the like may be variously considered by the user. Accordingly, also in the intermediate language set transmitting unit, a configuration is preferable which is capable of appropriately adjusting the timing at which the acquired intermediate language set is output to the speech synthesis unit. For example, in a case where the output of synthesized speech corresponding to a small amount of a text is requested from a user, as in a chatting application, a method is preferable in which the acquired intermediate language set is sequentially transmitted to the speech synthesis unit almost simultaneously with the acquisition thereof. On the other hand, as in an electronic book application, in a case where a speech synthesis process is performed using a plurality of speech dictionary sets for a text having a large amount of processing to some degree, a method may be considered in which acquired intermediate language sets are distributed for each corresponding speech dictionary set and are sequentially transmitted for each corresponding intermediate language set. In any case, by employing such a configuration, speech synthesis and the output of the synthesized speech under appropriate conditions requested from the user can be performed.

### Specific Configuration of Speech Synthesis Terminal

The hardware configuration of the speech synthesis terminal configuring the speech synthesis system according to this embodiment is basically the same as that of the speech synthesis terminal according to the seventh embodiment described with reference to FIG. 17. Hereinafter, specific processes of the reading text output unit, the intermediate language set acquiring unit, and the intermediate language set transmitting unit, which have not been described in the seventh embodiment, will be described.

### Specific Process of Reading Text Output Unit

By executing a “reading text output program”, the CPU transmits the reading text to the reading text input reception unit of the server apparatus through the communication device.

### Specific Process of Intermediate Language Set Acquiring Unit

By executing an “intermediate language set acquiring program”, the CPU acquires an intermediate language set corresponding to the reading text transmitted by executing the reading text output program from the intermediate language set output unit of the server apparatus through the communication device and stores the acquired intermediate language set at a predetermined address on the main memory.

### Specific Process of Intermediate Language Set Transmitting Unit

By executing an “intermediate language set transmitting program”, the CPU performs a process of reading an intermediate language set from a predetermined address in the main memory and outputting the intermediate language set to the speech synthesis unit.

### Flow of Process

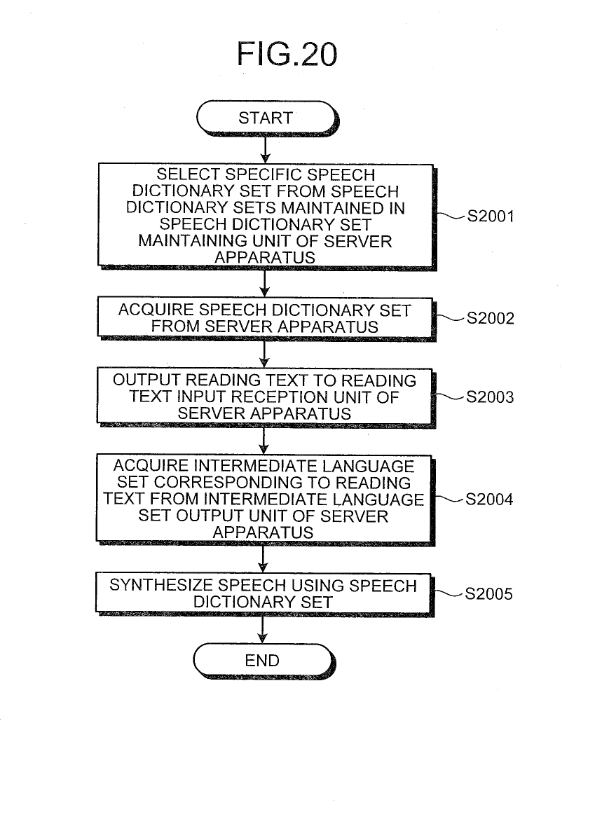

FIG. 20 is a diagram that illustrates an example of the flow of the control process of the speech synthesis terminal configuring the speech synthesis system according to this embodiment. The flow of the process illustrated in the figure is configured by the following steps. First, in Step S2001, a specific dictionary set is selected from among the speech dictionary sets maintained by the speech dictionary set maintaining unit of the server apparatus through the interface. Next, in Step S2002, the speech dictionary set is acquired from the server apparatus through the interface. Next, in Step S2003, the reading text is output to the reading text input reception unit of the server apparatus through the interface. Next, in Step S2004, an intermediate language set corresponding to the reading text is acquired from the intermediate language set output unit of the server apparatus through the interface. In Step S2005, speech is synthesized by using the speech dictionary set acquired through the selection and the intermediate language set.

### Advantages

According to the speech synthesis system including the speech synthesis terminal of this embodiment, the user can perform the process from the input of a text to the generation of synthesized speech by using the same terminal.

### Ninth Embodiment

### Overview

While a speech synthesis system according to this embodiment is basically the same as the speech synthesis system according to the seventh embodiment, the speech synthesis terminal operates an application using the synthesized speech that is synthesized by the speech synthesis unit and selects a speech dictionary set used by the speech synthesis unit in accordance with the operated application. By employing such a configuration of this embodiment having such a feature, synthesized speech corresponding to a plurality of applications considered to have various usage forms for the synthesized speech can be output.

### Functional Configuration

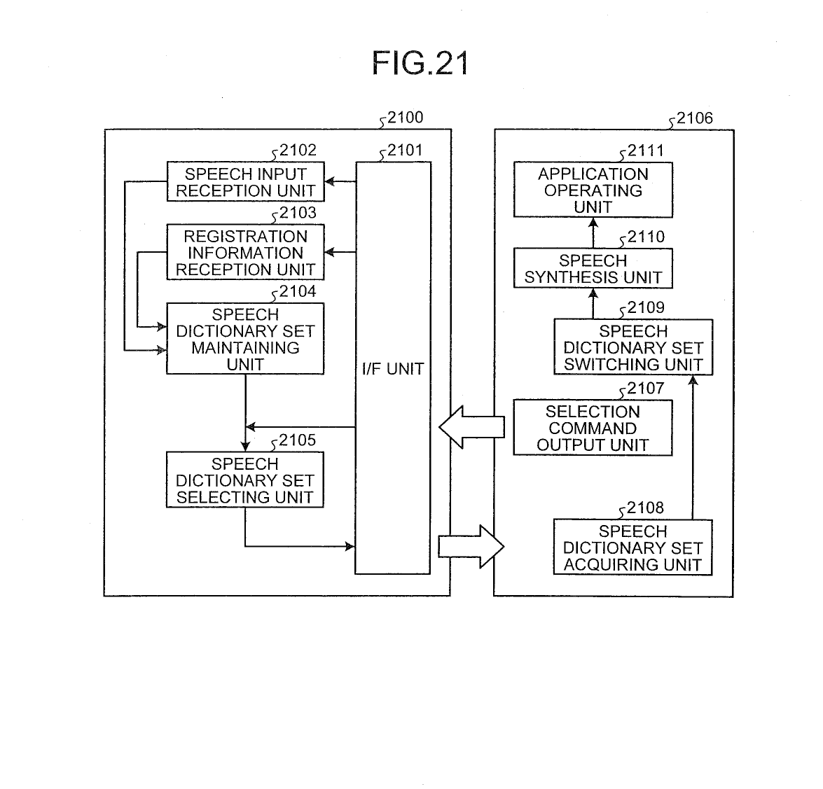

FIG. 21 is a diagram that illustrates an example of functional blocks of the speech synthesis system according to this embodiment. As illustrated in this figure, a “speech synthesis terminal” 2106 of the “speech synthesis system” according to this embodiment is configured by a “selection command output unit” 2107, a “speech dictionary set acquiring unit” 2108, a “speech dictionary set switching unit” 2109, a “speech synthesis unit” 2110, and an “application operating unit” 2111. Since the basic configuration of the speech synthesis terminal is mainly the same as that of the speech synthesis terminal of the speech synthesis system described in the seventh embodiment with reference to FIG. 16, hereinafter, the “application operating unit” and the “speech dictionary set switching unit”, which are different points, will be described.

The “application operating unit” has a function for operating an application using synthesized speech synthesized by the speech synthesis unit. As “applications using synthesized speech”, various kinds of applications may be considered. For example, various applications may be considered including an application using speech for its nature such as an animation application, an application using text information such as an electronic book application or a short message information transmission/reception application, and an application generating a specific sound such as an alarm application or a reminder application, and any of the applications can use synthesized speech.

Here, the meaning of the “using” will be described for an example of each application described above. In the case of the animation application, a method may be considered in which a speech given by a character of the application is output using synthesized speech. In a case where text information is used such as in the electronic book application or the short message information transmission/reception application, a method may be considered in which synthesized speech is used for reading a sentence that is the content. In addition, when reading is performed, a configuration may be employed in which speech is synthesized by using different speech dictionaries according to the characters or transmission/reception persons. By employing such a configuration, a plurality of synthesized speeches can be used in one application, and accordingly, the representation method that can be implemented using the application can be markedly widened. In addition, in the case of the alarm application or the reminder application, as the user outputs synthesized speech acquired by selecting a speech dictionary having characteristics according to his or her taste, an effect of urging to get up or to perform a scheduled operation can be improved without incurring stress.

The “speech dictionary set switching unit” has a function for selecting a speech dictionary set used by the speech synthesis unit in accordance with an operating application. The “selecting a speech dictionary set used by the speech synthesis unit in accordance with an operating application” represents that a speech dictionary set considered to be appropriate to the characteristics of the application by the user is changed to be selected. When this is substituted into each application example described above, in an animation having a content told by an old person, it is commonly considered that a speech dictionary set having registration information of an old person is preferably selected, and, in the electronic book application, similarly, it may be considered to switch to and use a speech dictionary set having registration information resembling the characteristics of a character who is the speaker. In an application such as the alarm application in which the reduction of user stress is one of the effects, the user may consider to select a speech dictionary set having registration information that the user likes.

Such switching and selecting has strong relation with the content and the characteristics of the corresponding application, and there are many cases where the presence/no-presence of the relation and the degree of relation are necessarily determined by the user, and accordingly, the function for selecting a speech dictionary set may be considered to be searched in association with the registration information for a plurality of speech dictionary sets. In addition, a method in which a switching history according to the user is maintained, and the speech dictionary sets are sorted and displayed in ascending order of the frequency so as to be selectable or a method in which the speech dictionary sets are sorted and displayed in order of latest acquisition time so as to be selectable, or the like may be considered.

### Specific Configuration of Speech Synthesis Terminal

The hardware configuration of the speech synthesis terminal configuring the speech synthesis system according to this embodiment is basically the same as that of the speech synthesis terminal according to the seventh embodiment described with reference to FIG. 17. Hereinafter, specific processes of the application operating unit and the speech dictionary set switching unit, which have not been described in the seventh embodiment, will be described.

### Specific Process of Application Operating Unit

By executing an “application operating program”, the CPU performs a process of operating an application using synthesized speech.

### Specific Process of Speech Dictionary Set Switching Unit

By executing a “speech dictionary set switching program”, the CPU performs a process of selecting a speech dictionary set executed by a speech synthesis program in correspondence with the operating application and stores a result thereof at a predetermined address in the main memory.

### Flow of Process

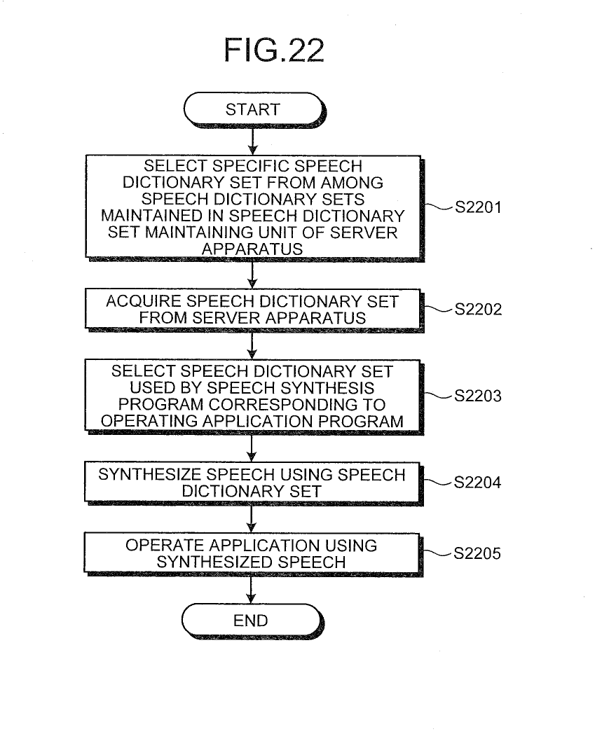

FIG. 22 is a diagram that illustrates an example of the flow of the control process of the speech synthesis terminal configuring the speech synthesis system according to this embodiment. The flow of the process illustrated in the figure is configured by the following steps. First, in Step S2201, a specific dictionary set is selected from among the speech dictionary sets maintained by the speech dictionary set maintaining unit of the server apparatus. Next, in Step S2202, the speech dictionary set is acquired from the server apparatus through the interface. Next, in Step S2203, a speech dictionary set used by the speech synthesis program is selected in accordance with the operating application to be described later. Next, in Step S2204, speech is synthesized by using the speech dictionary set. Next, in Step S2205, the application is operated using the synthesized speech.

### Advantages

According to the speech synthesis system including the speech synthesis terminal of this embodiment, synthesized speech corresponding to a plurality of applications of which various usage forms of the synthesized speech are considered can be output.

### Tenth Embodiment

### Overview

While a speech synthesis system according to this embodiment is basically the same as the speech synthesis system according to the ninth embodiment, in a case where the application operating by the application operating unit is a generation animation, the speech synthesis terminal synchronizes output timing of the animation and the output timing of the synthesized speech synthesized by the speech synthesis unit are synchronized. By employing such a configuration of this embodiment having such a feature, in a voice animation, synthesized speech can be output with a feeling of character's naturally speaking.

### Functional Configuration

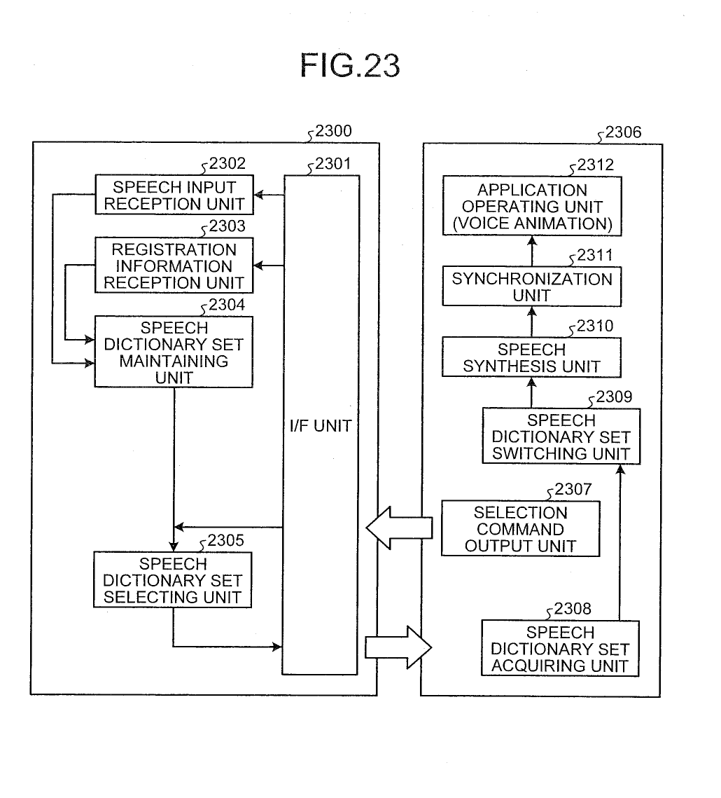

FIG. 23 is a diagram that illustrates an example of functional blocks of the speech synthesis system according to this embodiment. As illustrated in this figure, a “speech synthesis terminal” 2306 of the “speech synthesis system” according to this embodiment is configured by a “selection command output unit” 2307, a “speech dictionary set acquiring unit” 2308, a “speech dictionary set switching unit” 2309, a “speech synthesis unit” 2310, a “synchronization unit” 2311, and an “application operating unit” 2312. Since the basic configuration of the speech synthesis terminal is mainly the same as that of the speech synthesis apparatus of the speech synthesis system described in the ninth embodiment with reference to FIG. 21, hereinafter, the “synchronization unit”, which is a different point, will be described.

The “synchronization unit” has a function for synchronizing the output timing of an animation and the output timing of the synthesized speech that is synthesized by the speech synthesis unit in a case where the application operating in the application operating unit is the voice animation. In the case of the voice animation, when the synthesized speech is not output in accordance with the timing of the vocalization of an appearing character, each character is not visually recognized to speak the synthesized speech, and an animation such as an unnatural “lip-sync” is formed, and a situation occurs in which the output synthesized speech and the animation do not match each other. More specifically, a method may be considered in which the vocalization timing of each character in the voice animation is recorded in advance, and specific synthesized speech is output based on the recording.

### Specific Configuration of Speech Synthesis Terminal

The hardware configuration of the speech synthesis terminal configuring the speech synthesis system according to this embodiment is basically the same as that of the speech synthesis terminal according to the seventh embodiment described with reference to FIG. 17. Hereinafter, a specific process of the synchronization unit, which has not been described in the seventh embodiment, will be described.

### Specific Process of Synchronization Unit

By executing a “synchronization program”, the CPU performs a process of synchronizing the output timing of the animation and the output timing of the synthesized speech.

### Flow of Process

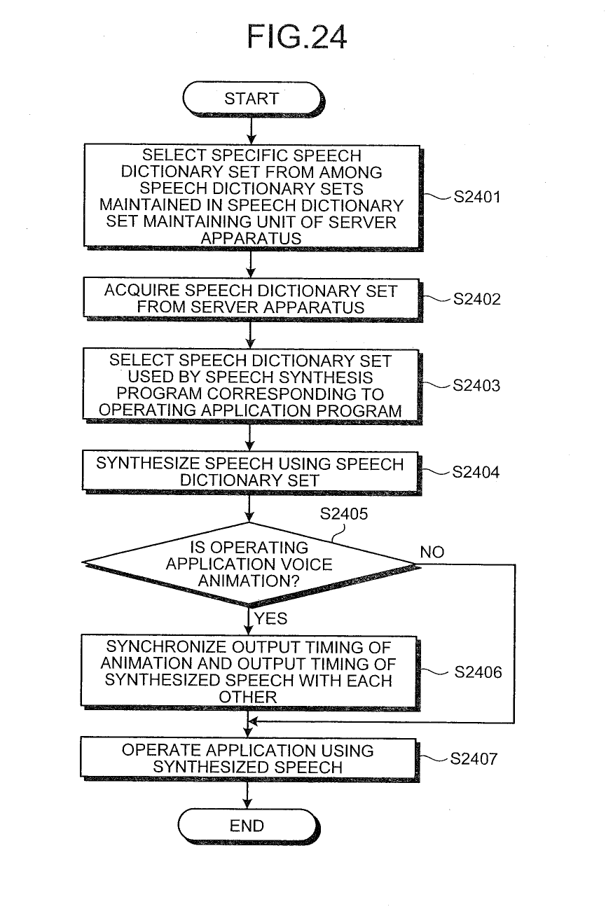

FIG. 24 is a diagram that illustrates an example of the flow of the control process of the speech synthesis terminal configuring the speech synthesis system according to this embodiment. The flow of the process illustrated in the figure is configured by the following steps. First, in Step S2401, a specific dictionary set is selected from among speech dictionary sets maintained by the speech dictionary set maintaining unit of the server apparatus. Next, in Step S2402, the speech dictionary set is acquired from the server apparatus through the interface. Next, in Step S2403, a speech dictionary set used by the speech synthesis program is selected in accordance with the operating application. In Step S2404, speech is synthesized by using the speech dictionary set. Next, in Step S2405, it is determine whether the operating application is a voice animation. In a case where the application is determined as the voice animation as a result of the determination, the process proceeds to Step S2406. On the other hand, in a case where the application is determined as not a voice animation, the process proceeds to Step S2407. In Step S2406, the output timing of the animation and the output timing of the synthesized speech are synchronized with each other. Next, in Step S2407, the animation application is operated using the synthesized speech.

### Advantages

According to the speech synthesis system including the speech synthesis terminal of this embodiment, in a voice animation, synthesized speech can be output with a feeling of character's naturally speaking.

According to an aspect of an embodiment of the present invention, speakers can freely store speech dictionary sets in which a rhythm model and a speech model that are characteristics of his or her own speech are recorded in a server and open the speech dictionary sets to the public. In addition, since the speech dictionary sets can be open to the public in an easy manner as described above, speech dictionary sets are provided by many speakers, and accordingly, a speech dictionary set according to the conditions requested from the user can be provided.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A speech synthesis system that synthesizes speech using a reading text and a speech dictionary set, the speech synthesis system comprising a server apparatus including:
an interface unit that is open to a public;
a speech input reception unit that receives an input of speech from an external terminal through the interface unit to generate a speech dictionary set;
a registration information reception unit that receives registration information relating to a speech owner who is a person inputting the speech from the external terminal through the interface unit;
a speech dictionary set maintaining unit that maintains a speech dictionary set generated from the speech of which the input has been received in association with the registration information of the person inputting the speech; and
a speech dictionary set selecting unit that allows selection of the speech dictionary set maintained in the speech dictionary set maintaining unit from the external terminal through the interface unit.

2. The speech synthesis system according to claim 1, wherein the server apparatus further includes
a reading text input reception unit that receives an input of a reading text through the interface unit.

3. The speech synthesis system according to claim 2, wherein the reading text input reception unit further includes:
a first prohibited text list maintaining unit that maintains a first prohibited text list which is a list of texts to be processed to be prohibited;
a first comparison unit that compares the input reading text and the first prohibited text list with each other; and
a first prohibition processing unit that performs a prohibition process to prohibit a use of a prohibited text in speech synthesis in accordance with a result of the comparison by the first comparison unit.

4. The speech synthesis system according to claim 2, wherein the server apparatus further includes
an intermediate language set generating unit that generates an intermediate language set used for synthesizing speech from the reading text using the speech dictionary set.

5. The speech synthesis system according to claim 2, wherein
the server apparatus further includes
an intermediate language set generating unit that generates an intermediate language set used for synthesizing speech from the reading text using the speech dictionary set, the intermediate language set generating unit further includes
a second prohibited text list maintaining unit that maintains a second prohibited text list which is a list of texts to be processed to be prohibited;
a second comparison unit that compares the reading text used for generating an intermediate language and the second prohibited text list with each other; and
a second prohibition processing unit that performs a prohibition process to prohibit a use of a prohibited text in speech synthesis in accordance with a result of the comparison by the second comparison unit.

6. The speech synthesis system according to claim 4, wherein the server apparatus further includes an intermediate language set output unit that outputs the generated intermediate language set to the external terminal through the interface unit.

7. The speech synthesis system according to claim 1, further comprising
a speech synthesis terminal, which is an external terminal, including:
a selection command output unit that outputs a selection command through the interface unit for selecting the speech dictionary set in the speech dictionary set selecting unit;
a speech dictionary set acquiring unit that acquires the speech dictionary set selected in accordance with the output selection command through the interface unit; and
a speech synthesis unit that synthesizes speech using the selected speech dictionary set.

8. The speech synthesis system according to claim 2, further comprising
a speech synthesis terminal, which is an external terminal, including
a selection command output unit that outputs a selection command through the interface unit for selecting the speech dictionary set in the speech dictionary set selecting unit;
a speech dictionary set acquiring unit that acquires the speech dictionary set selected in accordance with the output selection command through the interface unit;
a speech synthesis unit that synthesizes speech using the selected speech dictionary set,
a reading text output unit that outputs the reading text to the reading text input reception unit through the interface unit;
an intermediate language set acquiring unit that acquires the intermediate language set corresponding to the reading text output from the reading text output unit from the intermediate language set output unit through the interface unit; and
an intermediate set transmitting unit that outputs the acquired intermediate language set to the speech synthesis unit.

9. The speech synthesis system according to claim 7, wherein the speech synthesis terminal further includes:
an application operating unit that operates an application using the synthesized speech synthesized by the speech synthesis unit; and
a speech dictionary set switching unit that selects the speech dictionary set used in the speech synthesis unit in accordance with the operating application.

10. The speech synthesis system according to claim 9, wherein the speech synthesis terminal further includes a synchronization unit that synchronizes output timing of an animation and output timing of the synthesized speech synthesized by the speech synthesis unit when the application operated by the application operating unit is a voice animation.

11. A server apparatus comprising:
an interface unit that is open to a public;
a speech input reception unit that receives an input of speech from an external terminal through the interface unit to generate a speech dictionary set;
a registration information reception unit that receives registration information relating to a speech owner who is a person inputting the speech from the external terminal through the interface unit;
a speech dictionary set maintaining unit that maintains a speech dictionary set generated from the speech of which the input has been received in association with the registration information of the person inputting the speech; and
a speech dictionary set selecting unit that allows selection of the speech dictionary set maintained in the speech dictionary set maintaining unit from the external terminal through the interface unit.

12. A speech synthesis method for synthesizing speech using a reading text and a speech dictionary set, the speech synthesis method comprising:
receiving an input of speech from an external terminal through an interface unit, which is open to a public, to generate a speech dictionary set;
receiving registration information relating to a speech owner who is a person inputting the speech from the external terminal through the interface unit;
maintaining a speech dictionary set generated from the speech of which the input has been received in association with the registration information of the person inputting the speech; and
allowing selection of the speech dictionary set maintained in the maintaining from the external terminal through the interface unit.
